(19) United States
(12) Patent Application Publication
(10) Pub. No.: US 2009/0211184 A1
(43) Pub. Date: Aug. 27, 2009

(54) Fins and kerfs in extruded aluminum door frames and frame elements

(75) Inventor: Lawrence Frank Kerscher, DePere, WI (US)

Correspondence Address: WILHELM LAW SERVICE, S.C., 100 W LAWRENCE ST, THIRD FLOOR, APPLETON, WI, 54911, US

(73) Assignee: Bay Industires Inc., Green Bay, WI (US)

(21) Appl. No.: 12/322,294

(22) Filed: Jan. 29, 2009

Related U.S. Application Data
(63) Continuation-in-part of application No. 11/015,237, filed on Dec. 17, 2004.

(51) Int. Cl. E06B 1/14

(52) U.S. Cl. 52/204.1

(57) ABSTRACT

A door frame employs extruded aluminum jamb moldings, including extruded jambs, or jamb cover moldings in combination with jamb substrates. The extruded aluminum molding includes a mounting fin kerf. The kerf is generally boot-shaped, having an inwardly-disposed foot portion and an opening having an ankle-shaped cross-section. The mounting fin can be generally rigid, such as an extruded aluminum fin or a generally rigid polymeric fin. The kerf, in combination with the mounting fin, which has a bulbous rigid base, facilitates locking the fin in an erect orientation at about 75 degrees to about 90 degrees relative to the jamb body or the jamb substrate. The kerf/fin combination further provides improved ease of release of the fin from the erect orientation and facilitates rotating/retracting the fin into contact with the jamb body or jamb substrate.

### CROSS-REFERENCE TO RELATED APPLICATIONS

This application is a Continuation-in-Part of application Ser. No. 11/015,237, filed Dec. 17, 2004, which is herein incorporated by reference in its entirety. Accordingly, this application claims priority under 35 U.S.C. 120 to application Ser. No. 11/015,237.

### BACKGROUND

This invention pertains to prefabricated and otherwise assembled extruded aluminum door jambs and cooperating other elements, to door jamb assemblies, and to door frames.

When installing a door frame into a door opening in a building, it is desirable to have a strong, durable, rot and decay resistant, frame which is either prefabricated or easily assembled at the construction site. Preferably, the frame can be assembled at an off-site manufacturing location. In the alternative, it is desirable to have frame elements which are easily assembled at the construction site.

In a typical construction project involving entry doors, door frames or door jambs are fabricated by a frame or jamb fabricator, and are thence shipped to a door assembler. The door assembler typically receives the jambs or frames as fabricated, separately receives door slabs from a door slab supplier. The door assembler adds the desired glass inset, if any, to the door slab, assembles the door slab and a selected door frame to each other, and ships the thus-assembled door assembly, including frame and slab, to the construction site for installation on the building.

In a typical garage door project, the door assembler assembles a plurality of jamb assemblies which will collectively make up the door frame. Since an assembled garage door frame, because of its size and configuration, is typically inefficient to ship assembled, the door assembler or other supplier typically ships the jamb assemblies and the door panels as separate pieces, and the pieces are assembled at the construction site.

In the known art, the basic frame of the door, whether an entry door or a garage door, is commonly wood. The door assembler can up-grade the quality and value of the frame, and thus the quality and value of the door assembly, to some extent, by installing cladding such as extruded aluminum cladding to the left, right, and top/header frame wood substrate members, thus to provide maintenance free, tough, and durable exterior surfaces to the frame. Such extruded aluminum cladding is taught in U.S. Pat. No. 7,111,433 Kerscher, as well as pending application Ser. No. 11/005,725 Kerscher, filed Dec. 7, 2004.

Even where the wood jamb substrate is up-graded with extruded aluminum cladding, the support whereby the door frame supports the garage door or the slab of an entry door is at least in substantial part attributed to the strength of the wood in the door frame. Thus, the properties of the wood substrate still have substantial affect on the structural use life, and ongoing properties, of the door frame. Such wood substrate can be subject to attack by rot, insects, and other invasive organisms which cause the properties of the wood to deteriorate. Such deterioration typically starts at or near the bottom of the frame as a result of repeated and/or prolonged exposure to rain and other wet conditions. In some instances, such deterioration may be localized. In other instances, such deterioration spreads along the length of the jamb. While localized deterioration may not cause catastrophic failure of the door frame, the fact that localized deterioration may spread is cause for desiring door frames which are not subject to such frame deterioration.

For example, in exterior applications such as in a garage door frame, the bottom of the wood frame commonly is supported directly by an underlying surface such as concrete, dirt, or the like. Where the door frame is mounted as an exterior entrance to a building, the outwardly-disposed side of the door frame is subjected to the weather, including rain, snow, changes in temperature, changes in humidity, and the like. Such environmental conditions are detrimental to the long-term stability of the wood substrate. As a first example, the wood readily absorbs and holds water. So any rain can be a source of moisture which is absorbed by that portion of the wood, especially that portion of the wood which interfaces with the underlying ground or concrete, or which otherwise becomes wetted.

The moisture, as absorbed, can be wicked upwardly a few inches along the length of the wood substrate, generally in accord with the porosity and other wicking properties of the wood. While present in the wood, the moisture can support bacteria and/or other microscopic-size life forms which feed on the substances of the wood, causing loss of strength in the wood. Over a period of time, typically with repeated such exposures to water, the wood eventually decays to a form commonly known as rotten wood. Rotten wood does not have the structural qualities of wood which has not been so decayed, whereby the resulting door frame does not provide the desired degree of structural support for the door, and at least the affected portion of the frame fails.

Untreated wood is also subject to attack by insects, which also causes structural deterioration of the wood, and thus deterioration of support for the door.

Certainly, the door frame can be replaced or repaired. However, it is preferable to avoid the deterioration which accompanies wood structures at the doorway.

An extruded aluminum door frame is taught in pending application Ser. No. 12/229,763, filed Aug. 26, 2008. Such door frame has a conventional mounting fin kerf. A conventional vinyl mounting fin used therein has a living hinge near the base of the fin.

This invention provides a novel kerf, and novel mounting fin, useful in either an extruded aluminum jamb or in a jamb cover. The kerf and fin, in combination, provide for locking the fin in an erect orientation at an angle of about 75 degrees to about 90 degrees relative to the jamb body or jamb substrate.

The kerf/fin combination further provides improved ease of release of the fin from the erect orientation thereby to lie flat against the outer sheathing of the building when the jamb/frame is being installed in the building.

The fin/kerf combination further facilitates rotating/retracting the fin such that the distal edge of the fin lies in contact with the jamb or jamb substrate.

### SUMMARY

This invention provides a door frame which employs extruded aluminum door jambs, and door jamb assemblies, which are essentially devoid of untreated wood and other materials which are susceptible to being damaged by the affects of weather, insects, and microscopic life forms in those areas of the frame which will be subjected to substantial affects of weather, insects, and microscopic life forms.

Thus, the side jambs are fabricated of extruded aluminum moldings which extend from e.g. the floor, concrete, or other underlying substrate, to the header, which can be fabricated from a common-profile extruded aluminum molding.

An extruded aluminum nosing can be provided with the extruded aluminum molding, either integral with the extruded aluminum molding or readily assemblable to the extruded aluminum molding.

In some instances, the bottom of the extruded aluminum molding is raised off such floor, concrete or other underlying substrate, and a rear-mounted insert extends down from the extruded aluminum molding to such underlying substrate.

The rear-mounted insert can be polymeric, and can receive nails and/or screws as fasteners, directed inwardly into the building, optionally without pre-drilling, in much the same manner as wood receives nails or screws.

The extruded aluminum molding includes a mounting fin kerf, and a mounting fin received in the kerf. Such mounting fins are generally rigid, such as extruded aluminum mounting fins or generally rigid polymeric mounting fins. The kerf is generally boot-shaped, having an inwardly-disposed foot portion and a slot-shaped opening portion. The opening portion has an ankle-shaped cross-section. The kerf, in combination with a bulbous rigid base portion of the fin, facilitates locking the fin in an erect orientation at an angle of about 75 degrees to about 90 degrees relative to the jamb body or the jamb substrate.

The kerf/fin combination of the invention further provides improved ease of release of the fin from the erect orientation thereby to lie flat against the outer sheathing of the building when the jamb/frame is being installed in the building.

The fin/kerf combination further facilitates rotating/retracting the fin, e.g. for shipping, such that the distal edge of the fin lies in contact with the jamb or jamb substrate.

In a first family of embodiments, the invention comprehends an extruded aluminum door jamb, having a length, and being adapted to be received, as part of a door frame, into a rough opening in a building. The door jamb comprises a jamb body having a length and comprising (i) a first side facing toward the rough opening, (ii) a second side facing away from the rough opening, (iii) an outer side facing outwardly of the building, and (iv) an inner side facing inwardly into the building; a nosing, attached to the jamb body and extending outwardly of the building, away from the outer side of the jamb body, the nosing having a length; and a single elongate mounting fin kerf extending along the length of the nosing, the elongate mounting fin kerf having a boot-shaped cross-section defined by an inwardly-disposed foot portion having a generally foot-shaped cross-section having a toe end and a heel end, and a slot-shaped opening portion having an ankle-shaped cross-section at the heel end of the foot portion, the slot-shaped opening portion leading from the foot portion out of the kerf and into the outside ambient environment, the slot-shaped opening portion having a toe side and a heel side, the heel side of the slot-shaped opening portion extending from the foot portion to the outside ambient environment along a generally straight line.

In some embodiments, the door jamb assembly further comprises an elongate generally rigid mounting fin in the kerf, the mounting fin having a base portion received in the kerf, and a distal side remote from the base portion, the mounting fin being movable to a retracted orientation wherein the distal side of the mounting fin is located generally proximate the second side of the jamb body, and being movable to an erected orientation wherein the distal side is displaced from the second side of the jamb body, and wherein the mounting fin can be locked in the erected orientation by interference between (i) the base portion of the mounting fin and (ii) the heel side wall and the toe side wall of the mounting fin kerf, the mounting fin, when so locked in the kerf, in the erected orientation, defining a minimum angle of about 75 degrees to about 90 degrees with respect to the second side of the jamb body.

In some embodiments, the jamb body has a plurality of panels defining the first side, the second side, the outer side, and the inner side, which plurality of panels collectively have an overall average panel thickness of about 0.055 inch to about 0.075 inch.

In some embodiments, at least one of the panels has a first generally lesser thickness portion about 0.04 inch thick to about 0.10 inch thick, and at least one of the panels has a second generally greater thickness portion which is about ten percent to about twenty-five percent thicker than the first lesser thickness portion.

In some embodiments, the door jamb assembly further comprises a rear-opening cavity disposed rearwardly in the door jamb assembly, and an insert is disposed in the rear-opening cavity, the insert having an end surface facing, and proximate, the inner side of the jamb body.

In some embodiments, the first and second sides comprise respective first and second side panels, further comprising a rear-opening cavity disposed relatively rearwardly in the jamb body of the inner side and extending along the length of the jamb body, the rear-opening cavity being defined in part by extensions of the first and second side panels rearwardly from the inner side, further comprising an insert in the cavity, the insert having first and second side walls, recesses and protuberances collectively disposed in the extensions of the first and second side panels of the jamb body, and in the first and second side walls of the insert, cooperating with each other thereby to hold the insert in the rear-opening cavity, and wherein the first and second side panels of the cavity have terminal ends, and wherein the insert extends rearward of the terminal ends and outwardly of the cavity.

In some embodiments, the door jamb assembly further comprises an elongate generally rigid mounting fin in the kerf, the mounting fin having a base portion and a distal side, (i) the mounting fin being movable to, and lockable in, an erected orientation wherein the distal side of the mounting fin is displaced from the second side of the jamb body, and (ii) the mounting fin being adapted to be unlocked from the erected orientation and moved to a retracted orientation wherein a portion of the mounting fin can lie against the second side of the jamb body.

In some embodiments, the door jamb assembly further comprises an elongate generally rigid mounting fin in the kerf, the mounting fin being movable to, and lockable in, an erected orientation wherein the distal side of the mounting fin is displaced from the second side of the jamb body, and the mounting fin being adapted to be unlocked from the erected orientation and rotated toward the second side of the jamb body, the unlocking of the mounting fin from the erected and locked orientation being effected by pulling the mounting fin in a direction generally perpendicularly away from the second side of the jamb body.

In a second family of embodiments, the invention comprehends a door jamb assembly, having a length, and being adapted to be received, as part of a door frame, into a rough opening in a building. The door jamb assembly comprises an extruded aluminum jamb body having a length, and comprising (i) a first side facing toward the rough opening, (ii) a second side facing away from the rough opening, (iii) an outer side facing outwardly of the building, and (iv) an inner side facing inwardly into the building;

a nosing attached to the jamb body and extending outwardly of the building, away from the outer side of the jamb body, the nosing having a length;

a single elongate mounting fin kerf extending along the length of the nosing, the mounting fin kerf having a slot-shaped opening defined by a heel side wall and a toe side wall; and an elongate generally rigid mounting fin in the kerf, the mounting fin having a base portion received in the kerf, and a distal side remote from the base portion, the mounting fin being (i) movable to a retracted orientation wherein the distal side of the mounting fin is located generally proximate the second side of the jamb body, and (ii) movable to an erected orientation wherein the distal side is displaced from the second side of the jamb body, and wherein the mounting fin can be locked in the erected orientation by interference between (i) the base portion of the mounting fin and (ii) the heel side wall and the toe side wall of the mounting fin kerf, the mounting fin, when so locked in the mounting fin kerf, in the erected orientation, defining a minimum angle of about 75 degrees to about 90 degrees with respect to the second side of the jamb body.

In some embodiments, the mounting fin, when so locked in the mounting fin kerf, in the erected orientation, defines a minimum angle of about 80 degrees to about 90 degrees with respect to the second side of the jamb body.

In some embodiments, the combination of the kerf and the base portion of the mounting fin are adapted such that the mounting fin can be unlocked from the erected orientation by pulling the mounting fin in a direction generally perpendicularly away from the second side of the jamb body.

In some embodiments, the single elongate mounting fin kerf has a boot-shaped cross-section defined by an inwardly-disposed foot portion having a generally foot-shaped cross-section having a toe end and a heel end, the slot-shaped opening being located proximate the heel end of the foot portion and having an ankle-shaped cross-section, the heel side wall of the slot-shaped opening extending from the heel end of the foot portion to the outside ambient environment along a generally straight line.

In some embodiments, the first side comprises a first side panel, the second side comprises a second side panel, the outer side comprises an outer side panel, and the inner side comprises an inner panel, the jamb body further comprising a rear-opening cavity disposed rearwardly in the jamb body relative to the inner side, and extending along the length of said jamb body, the rear-opening cavity being defined in part by extensions of the first and second side panels, which extend past the inner panel, the extensions of the first and second side panels having terminal ends, the rear-opening cavity having a front and a rear, the front of the rear-opening cavity being defined by the inner panel, said inner panel extending between the extensions of the first and second side panels, the rear-opening cavity further comprising an elongate rear opening extending along the length of the jamb body rearwardly of the inner panel and thereby enabling an insert in the rear-opening cavity to extend, from inside the rear-opening cavity, outwardly beyond the terminal ends of the extensions of the first and second side panels.

In a third family of embodiments, the invention comprehends a door jamb assembly, having a length, and being adapted to be received, as part of a door frame, into a rough opening in a building. The door jamb assembly comprises an extruded aluminum jamb body having a length, and comprising (i) a first side facing toward the rough opening, (ii) a second side facing away from the rough opening, (iii) an outer side facing outwardly of the building, and (iv) an inner side facing inwardly into the building;

a nosing attached to the jamb body and extending outwardly of the building, away from the outer side of the jamb body, the nosing having a length;

a single elongate mounting fin kerf extending along the length of the nosing, the mounting fin kerf having a slot-shaped opening defined by a heel side wall and a toe side wall; and

an elongate generally rigid mounting fin in the kerf, the mounting fin having a base portion and a distal side, (i) the mounting fin being movable to, and lockable in, an erected orientation wherein the distal side of the mounting fin is displaced from the second side of the jamb body, and (ii) the mounting fin being adapted to be unlocked from the erected orientation and moved to a retracted orientation wherein a portion of the mounting fin can lie against the second side of the jamb body.

In some embodiments, the distal side of the mounting fin contacts the second side of the jamb body when the mounting fin is in the retracted orientation.

In a fourth family of embodiments, the invention comprehends a door jamb assembly, having a length, and being adapted to be received, as part of a door frame, into a rough opening in a building. The door jamb assembly comprises an extruded aluminum jamb body having a length, and comprising (i) a first side facing toward the rough opening, (ii) a second side facing away from the rough opening, (iii) an outer side facing outwardly of the building, and (iv) an inner side facing inwardly into the building;

a nosing attached to the jamb body and extending outwardly of the building, away from the outer side of the jamb body, the nosing having a length;

a single elongate mounting fin kerf extending along the length of the nosing, the mounting fin kerf having a slot-shaped opening defined by a heel side wall and a toe side wall; and

an elongate generally rigid mounting fin in the kerf, (i) the mounting fin being movable to, and lockable in, an erected orientation wherein a distal side of the mounting fin is displaced from the second side of the jamb body, and (ii) the mounting fin being adapted to be unlocked from the erected orientation and rotated toward the second side of the jamb body, the unlocking of the mounting fin from the erected and locked orientation being effected by pulling the mounting fin in a direction generally perpendicularly away from the second side of the jamb body.

### BRIEF DESCRIPTION OF THE DRAWINGS

FIG. 1 shows a pictorial view of a first embodiment of door frames of the invention, with parts cut away, as a garage door frame, with the garage door partially lifted.

FIG. 2 shows a cross-section of a first embodiment of door jambs, including integral nosing structure, used in door frames of the invention.

FIG. 3 shows a cross-section of a brick mold casing which can be mounted to the jamb of FIG. 2.

FIG. 4 shows a cross-section of an assembly of the jamb of FIG. 2 and the brick mold casing of FIG. 3.

FIG. 5 shows a cross-section of an extended width casing which can be mounted to the jamb of FIG. 2.

FIGS. 6 and 6A show cross-sections of assemblies of the jamb of FIG. 2, and the casings of FIGS. 3 and 5, and including a durable mounting member insert received in a rear-opening rear cavity of the jamb.

FIG. 7 shows an enlarged cross-section of the jamb assembly of FIG. 1, and is taken at 7-7 of FIG. 1.

FIG. 8 shows an end view of an “L-shaped” spring clip which can be used at mitered corners of jamb elements used in door frames of the invention.

FIG. 9 shows a bottom view of the spring clip of FIG. 8.

FIG. 10 shows an edge view of a 90 degree angle corner gusset which can be employed in the jambs at right-angle corners of the door frame.

FIG. 11 shows an enlarged front elevation view of an upper corner of a garage door frame of the invention, with parts cut away, incorporating the corner gusset of FIG. 10, taken illustratively at dashed circle 11 in FIG. 1.

FIG. 12 shows a rear view of the upper corner of the door frame of FIG. 11, as seen from inside the building.

FIG. 13 shows an edge view of a 22.5 degree corner gusset which is employed in jamb elements having 45 degree gusseted corners of a door frame of the invention.

FIG. 14 shows an enlarged front elevation view of an upper corner as in FIG. 11 and wherein the corner structure includes use of 22.5 degree corner gussets of FIG. 13 and an angled cross-member, to create the 45 degree gusseted corner.

FIG. 15 shows a cross-section of another second embodiment of door jamb assemblies of the invention, showing a second embodiment of the jamb, a separate nosing, and a durable, non-wood mounting member insert indicated in dashed outline as being received in a rear cavity of the jamb.

FIG. 16 shows a cross-section of yet another embodiment of door jamb assemblies of the invention, showing a third embodiment of the jamb, a separate nosing, and a durable non-wood mounting member insert indicated in dashed outline as being received in a rear-opening rear cavity of the jamb.

FIG. 17 shows a cross-section of still another embodiment of door jamb assemblies of the invention, showing a fourth embodiment of the jamb, a separate nosing, and a durable non-wood mounting member insert indicated in dashed outline as being received in a rear-opening rear cavity of the jamb.

FIG. 18 shows a cross-section of a further embodiment of door jamb assemblies of the invention, mounted to framing which frames a doorway rough opening, wherein the durable, rearwardly-disposed, rearwardly-opening, insert-holding cavity structure has been replaced with a cavity which has a closed rear; and wherein mounting holes along the length of the jamb assembly receive fasteners which extend through left and right side panels of the door jamb at the rear cavity, and which secure the door jamb to the doorway rough opening framing members of the building.

FIG. 19 shows a cross-section of yet another embodiment of door jamb assemblies of the invention, including a depth extender received in the rear-opening rear cavity of the jamb body, and a durable, non-wood mounting member insert received in a rear-opening rear cavity of the depth extender.

FIGS. 20A, 20B, 20C, and 20D show the door jamb of FIG. 19 without the depth extender, with the insert in the rear-opening rear cavity, and with a mounting fin in the integral nosing.

FIG. 20A-1 is an enlarged portion of the nosing end of the door jamb of FIG. 20A.

FIGS. 21A, 21B, 21C, and 21D show a prior art jamb cover and nosing assembly, with a prior art mounting fin in the kerf in the separate nosing.

The invention is not limited in its application to the details of construction or the arrangement of the components set forth in the following description or illustrated in the drawings. The invention is capable of other embodiments or of being practiced or carried out in other various ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

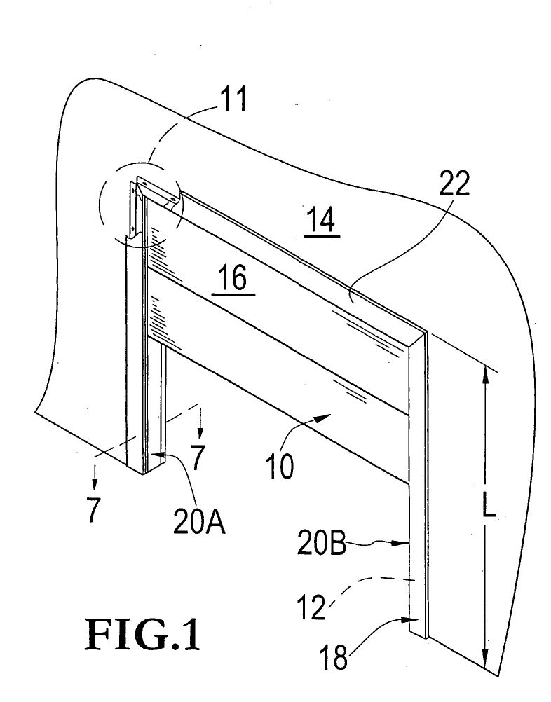

Turning now to the drawings, FIG. 1 shows a garage door 10 mounted in a rough opening 12 in a building 14. As illustrated, the garage door is partially open, such that only two of the commonly-used four garage door panels 16 are visible.

FIG. 1 shows, in general, a door frame 18, which includes left 20A and right 20B side jamb assemblies generally designated 20, and a header jamb assembly 22 extending across the top of the rough opening and connected to the two side jamb assemblies. The side jamb assemblies and the header jamb assembly have generally common cross-sections, whereby the description of one of the side jamb assemblies is effective to describe the header jamb assembly and the other side jamb assembly.

The rough opening, and correspondingly the finished opening, is sized, adapted, and configured to cooperate with a door to be used in conjunction with the frame. Thus, when the frame is used in entry door applications, the distance between the side jamb assemblies has a magnitude at least equal to the minimum dimension typically required for personnel entry uses, for example at least about 2 feet 8 inches, and typically up to about 42 inches, and all dimensions in between, for a single door slab. Where double doors are used, the dimension is correspondingly greater. Alternatively, when the frame is used in garage door applications, the distance between the side jamb assemblies has a magnitude at least equal to the minimum dimension typically required for garage door uses, namely at least about 7 feet, 8 feet, 10 feet, 15 feet, 16 feet, 18 feet, and all dimensions in between. Thus, the dimension between the side jamb assemblies is selected according to the anticipated use of the door frame, and the respective door assembly.

Similarly, the height of the door frame, to the header jamb assembly, is selected according to the desired height of the doorway opening.

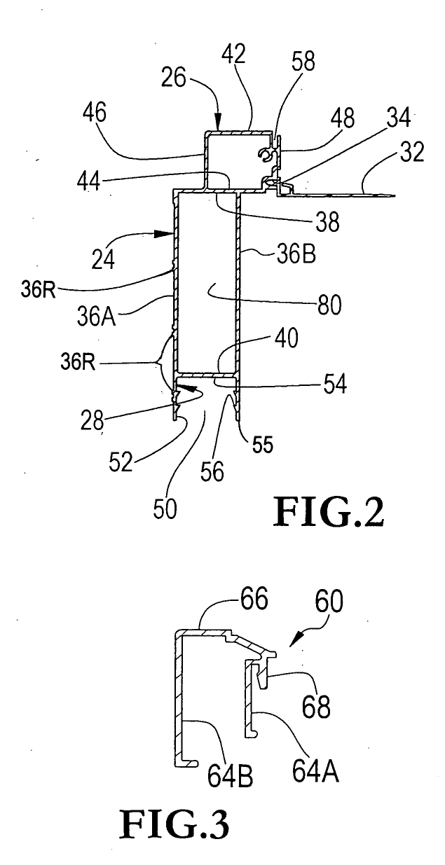

FIG. 2 shows an aluminum extrusion in the form of a jamb which includes a jamb 24, and a nosing, illustrated as integral nosing 26, whereby the jamb body and the nosing, collectively, at least partially define the generally unitary door frame. As used herein, the terms extrusion, molding, extruded, and molded, refer to various fabrication processes, all of which include extruding and shaping an aluminum profile through a die and wherein the aluminum has been softened/heated enough to enable such extruding, shaping of the profile of the aluminum through the shaping die.

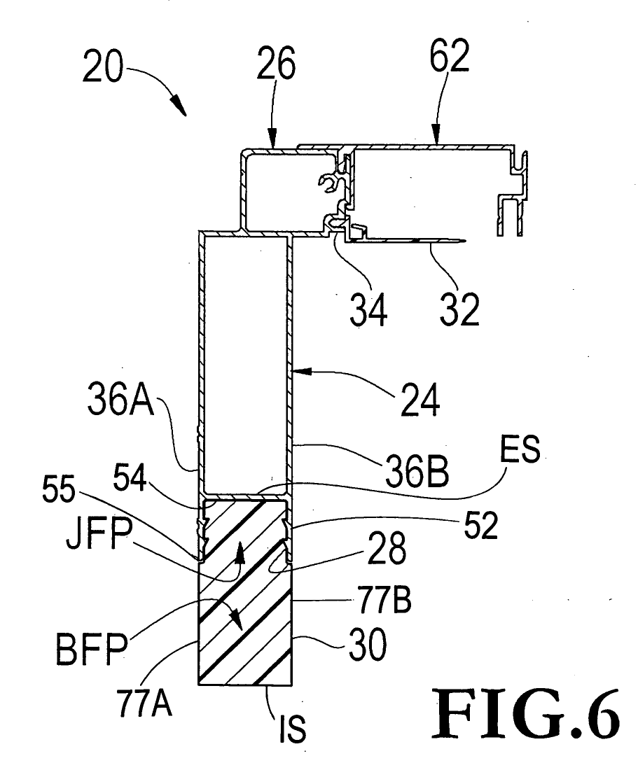

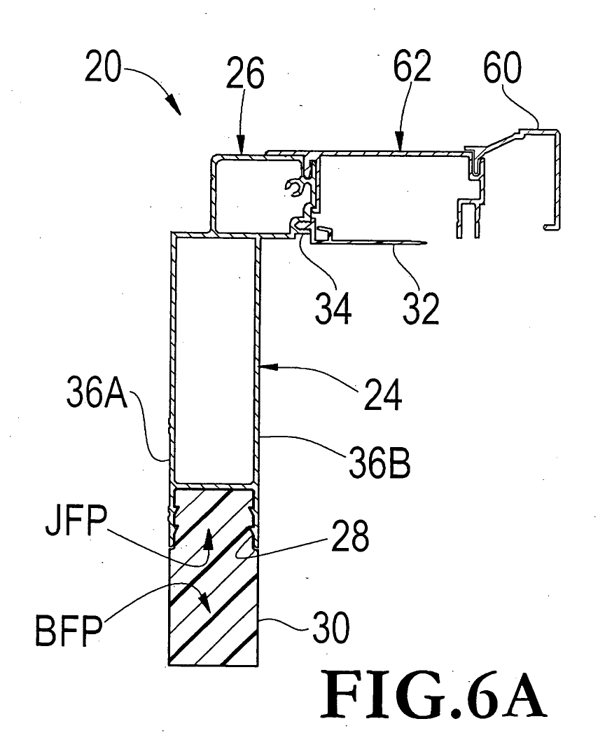

Jamb body 24 further includes a rear-opening rear cavity 28 adapted to receive an insert 30, illustrated in FIG. 6. Referring to FIG. 2, a mounting fin 32 is shown mounted in a mounting fin receptacle, namely fin kerf 34, in the nosing. Jamb body 24 is generally defined by left 36A and right 36B side panels, outer panel 38, and inner panel 40, along with nosing 26. In the assembled, installed, door frame, the left side panel 36A of the jamb body faces into the doorway opening and right side panel 36B faces the building framing members which define the rough opening. Outer panel 38 of the jamb body faces outwardly of the building and inner panel 40 faces inwardly toward the inside of the building.

In the embodiment of FIG. 2, nosing 26 is defined by outer wall 42, inner wall 44, and sides 46, 48. The inner wall of the nosing and the outer panel of the jamb body are each defined in part by a common strip of the extruded aluminum material. Side 46 faces into the doorway opening and is located away from the rough opening relative to jamb body left side panel 36A.

Cavity 28 defines an elongate opening 50 open to the rear of the jamb body extrusion and extending along a substantial portion of the length of the jamb body, optionally along substantially the full length of the jamb body, optionally along the entirety of the length of the jamb body. Rear cavity 28 is in general defined by left and right side walls 52, which are extensions of side panels 36A and 36B, and by front wall 54 which corresponds to inner panel 40 of the jamb body, as well as by opening 50. Thus, left and right side walls 52 at least partially define a rearmost portion, e.g. rear, of the aluminum extrusion jamb body, including at or adjacent, for example, terminal ends 55 of side panels 36A, 36B which are distal the remaining elements of jamb body 24. And the rib which extends between the left 36A and right 36B side panels of the jamb body serves both as the inner wall 40 of the jamb body 24 and as the front wall 54 of rear cavity 28.

Protuberances 56 project into cavity 28 from side walls 52. Protuberances 56 are designed with abutting surfaces which are generally perpendicular to side walls 52 and which abutting surfaces generally face toward nosing 26. The abutting surfaces on protuberances 56 are designed to interface with corresponding rearwardly-facing surfaces of insert 30, which surfaces can be at least in part defined by channels, grooves, chamfers, bevels, or other inward projections and/or other structure, formed into or extending from, insert 30 thereby to impede and/or prevent withdrawal of the insert from the cavity toward the rear of the jamb, namely toward the interior of the building.

An elongate recess 58, e.g. a casing-receiving recess, extends along the length of outer wall 42 of the nosing, and is adapted to receive thereinto, and hold, an elongate casing such as a brick mold 60 or a generally flat casing, e.g. extended-width casing 62 (FIG. 5). FIG. 3 illustrates a brick mold casing 60. Casing 60 includes right and left side walls 64A, 64B and outer wall 66. An elongate mounting stub 68 extends parallel to, and offset from, side wall 64A and extends away from outer wall 66. Stub 68 is sized and configured to fit into, and to frictionally engage, recess 58, thereby to mount casing 60 to the nosing by friction engagement between the nosing and the casing.

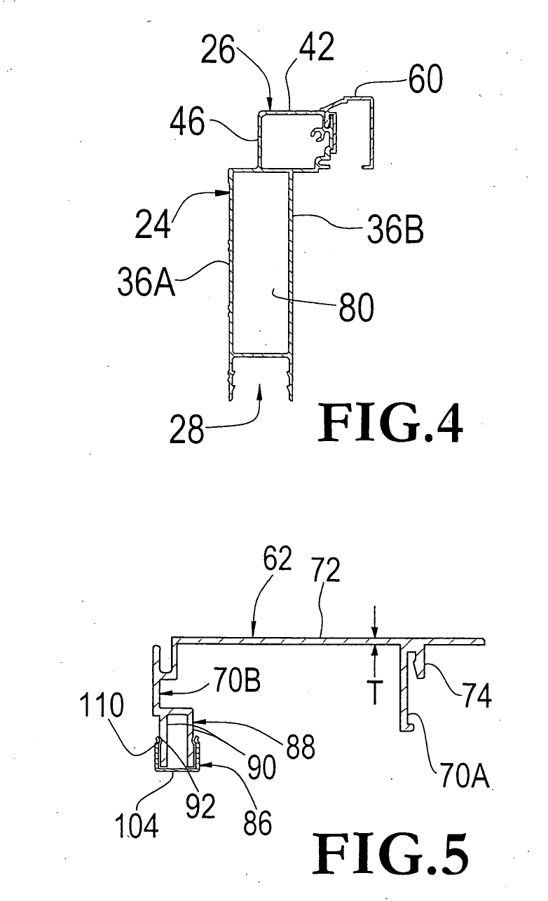

FIG. 5 shows extended-width flat casing 62. Casing 62 includes right and left side walls 70A, 70B, and outer wall 72. Stub 74 is sized and configured to fit into, and to frictionally engage, recess 58, thereby to mount casing 62 to the nosing by frictional engagement between the nosing and the casing. In the assemblage of casing 62 and jamb body 24, the outer, flat surface of casing 62 is substantially co-planar with an outer surface of nosing 26. As can be seen by comparing FIGS. 4 and 6, in general, either casing 60 or casing 62 can be mounted in a given recess 58.

Referring now to FIGS. 1, 6, and 7, a given side jamb assembly 20 typically includes an extruded aluminum jamb body 24, and can include a nosing 26 integral with the jamb or, as discussed hereinafter, mounted as a separate element to the jamb body. A casing 60, 62, or both, can, as illustrated in FIGS. 4, 6, and 6A, be mounted to the jamb, through an integral nosing, or through a separate-element nosing. A mounting fin 32 can be mounted directly to the jamb such as at nosing 26.

Referring to FIG. 6, a durable, rot, decay, and insect resistant, insert 30 can be mounted in the jamb to serve as a stiffening member, and/or to serve as an attachment structure whereby the jamb assembly can be nailed, or screwed, or otherwise mounted, to one or more building framing members. Insert 30 has a jamb body facing portion “JFP” and a building facing portion “BFP”. Jamb-body-facing portion “JFP” of insert 30 generally faces and communicates with jamb body 24, and building facing portion “BFP” of insert 30 generally faces away from the jamb body and “into” the building, in the installed product. As illustrated in FIG. 6, a terminal end surface “ES” of jamb body facing portion “JFP” interfaces with, abuts, and/or otherwise communicates with, or is proximate, an edge or surface, e.g. cavity front wall 54 or other edge and/or surface, such as terminal ends 55, of jamb body 24.

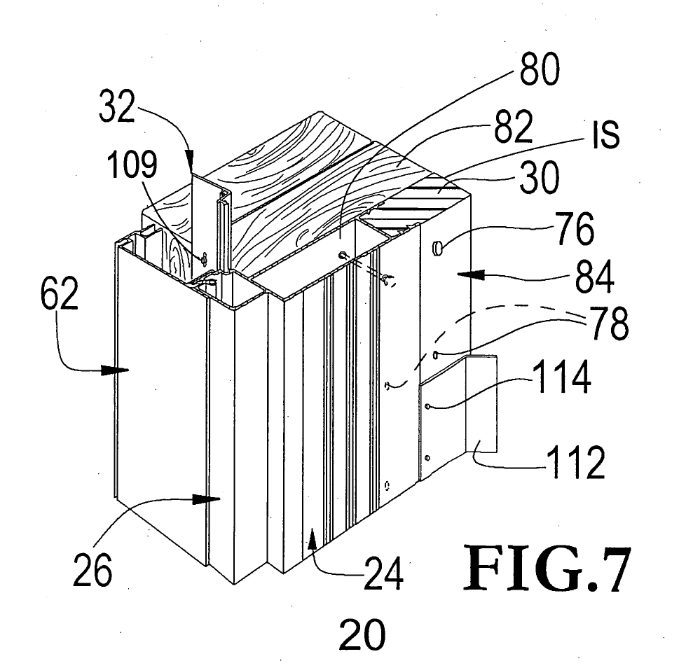

In the embodiment illustrated in FIGS. 6 and 7, at least part of the jamb body facing portion “JFP” of insert 30 has a width dimension which is of lesser magnitude, between left side wall 77A and right side wall 77B, than the width dimension of the building facing portion “BFP”. The illustrated difference in the magnitudes of the widths of the jamb facing portion “JFP” and building facing portion “BFP” corresponds generally to the magnitude of the sum of the thickness dimensions of left and right cavity side walls 52 which are generally configured as extensions of side panels 36A, 36B, respectively. The width of the jamb facing portion is generally configured to interface with protuberances 56 in holding the insert in the cavity. The building facing portion needs to present a surface at side wall 77B which can interface with the building framing. From side wall 77B, the building facing portion only needs to be thick enough to satisfy structural requirements related to maintaining the insert in rear cavity 28 and to keep the jamb mounted securely to the building framing.

When insert 30 is housed in rear cavity 28, the outer surface of left side panel 36A and the portion of the outer surface of the left side wall 77A of insert 30 which extends beyond the cavity side wall 52 can collectively define a generally planar surface e.g. with no substantial step change in surface profile height along at least a major portion of the collective surface thereof.

In the alternative, the portion of the outer surface of the left side wall 77A of insert 30 which extends beyond the cavity side wall 52 can define a narrower segment of the insert rearward of a surface of the insert, which surface abuts left terminal end 55 of the aluminum extrusion. Such narrower segment can be defined by a perpendicular step change, by an acute angle step change, or an obtuse angle or any other angle step change, or by a curvilinear change. In any event, where the jamb is mounted to the building framing by driving fasteners through the insert, a portion of left side wall 77A, frontwardly of inner surface “IS” of the insert, is optionally parallel to right side wall 77B.

The outer surface of right side panel 36B and the portion of the outer surface of the right side wall 77B of insert 30 which extends beyond the cavity side wall 52 generally collectively define a generally planar surface e.g. with no substantial step-change in surface profile height along at least a major portion of the collective surface thereof, such that right side panel 36B of the extrusion and the right side wall of insert 30 present a generally common planar surface for interfacing with the building framing.

Also as illustrated, the jamb body facing portion “JFP” of the insert has at least one interfacing structure which is adapted and configured to interface with the protuberances of the cavity side walls 52. In FIG. 6, each of the interfacing structures is an asymmetric “V-type” groove, which has first and second terminally intersecting groove walls. One of the groove walls extends generally perpendicularly into insert 30 relative to the respective side wall 52, and the other of the groove walls extends into insert 30 at an angle which intersects the perpendicular groove wall. Other interfacing structures are contemplated and are well within the scope of the invention, including, but not limited to, channels, grooves, chamfers, bevels, or other inward projections and/or other structures, or which may be mirror images of such channels, grooves, chamfers, levels, or other inward projections, and which are formed into or which extend from, insert 30.

The insert 30 illustrated in FIG. 6 is disposed at a location generally toward the interior of the building from front wall 54, and generally to the rear of jamb body 24. In such instance, and as illustrated in FIG. 7, nails 76 or screws (not shown) can be driven through the insert much like nails and screws are commonly driven through wood structural members, since the insert extends along the length of the jamb body and rearwardly of a rear portion of the jamb body and since insert 30 can accept fasteners and/or other hardware therethrough.

Depending on the material composition of insert 30, and the structure of the respective nails or screws, mounting holes 78 may or may not be pre-drilled or punched, as round or slotted holes in insert 30. Where a softer material such as polyethylene, or the like is used, pre-drilled holes are generally not required. Where a harder material such as polycarbonate or an acrylic is used in fabricating insert 30, pre-drilled holes may be desirable.

Insert 30 can be fabricated from, for example and without limitation, various of the polyethylenes, polyesters, polyamides, vinyl, acrylic, polycarbonate, or the like. Typically, a generally hydrophobic thermoplastic material is selected as the base material for use in insert 30. As additional compositional ingredients, a wide array of additives and fillers can be used to enhance the properties of the resultant insert, and/or to reduce the cost of the insert. In general, any additive such as a filler must be compatible with any such polymeric resin, and the proportion of the ingredients must be such that the polymeric resin is sufficiently continuous in the combination to prevent substantial absorption of water into the finished combination. Suitable fillers include, but are not limited to, wood particles, other cellulosic material, fibrous material, other organic and/or inorganic fillers, combinations thereof, and others.

Thus, in general, the polymeric resin is a continuous phase in the combination, and any hygroscopic filler or other inclusions are discontinuous inclusions in the continuous resin phase. A modest level of foaming, namely voids, is acceptable in insert 30 so long as the hydrophobic properties of the insert are preserved.

Further, insert 30 can be fabricated from wood which has been treated so as to not be susceptible to being attacked by insects and micro-organisms which commonly damage wood in exterior, non-enclosed environments. While such treated wood does wick/absorb water from the environment, and while such wetted wood normally would provide a suitable living and feeding environment for organisms which destroy/damage the structural elements of the wood, the chemical treatment in the wood prevents and/or effectively attenuates damage by such living organisms over the expected use life of the door frame.

In some embodiments, the insert, or a portion of the insert, or a second insert, can be disposed frontwardly of the inner panel 40 of the jamb body, which corresponds to the front wall 54 of the rear cavity, thus between inner panel 40 and outer panel 38. Where such insert is disposed frontwardly of the inner panel of the jamb body, such insert is desirably, but not necessarily, disposed proximate the inner panel. In such instance, such insert is located inside the tubular cavity 80 which is defined between side panels 36A, 36B, outer panel 38, and inner panel 40.

Mounting holes 78, shown in dashed outline in FIG. 7, are pre-drilled through aluminum side panels 36A, 36B of jamb body 24, and are also illustrated as being pre-drilled through insert 30 (illustrated in solid outline). Pairs of such holes on opposing side panels of the jamb body are in registration with each other such that a nail or screw can be driven through side panels 36A, 36B, generally along a straight line path, and into the respective framing members 82 of the building which define the rough opening in the building.

Holes 78 in the insert generally extend most of the way, or all the way, through the insert thus to guide and/or facilitate driving nails and/or screws through the insert and into the respective framing members of the building.

Holes 78, whether through jamb body 24 or through insert 30, or both, are generally longitudinally spaced from each other along the length of the jamb.

In the embodiments illustrated in FIGS. 1, 2, 6, and 7, insert 30 generally fills cavity 28 between left and right side walls 52, and extends to the rear of the cavity, namely to the rear of the jamb, by a distance sufficient to provide a substantial nailing surface 84 on the insert for driving nails or screws through the insert and into framing members 82 of the building well ahead (outwardly of the building) of the inward edges of the framing members.

Insert 30, as illustrated, provides two benefits to the jamb assembly. First, insert 30 interfaces with substantial portions of the inner surfaces of side walls 52, thereby transferring its own inherent stiffness to the cavity side walls, thus providing a stiffening benefit to the jamb, and enhancing the ability of the jamb to reduce the magnitudes of deformations which result from outside forces being imposed on the jamb. Second, insert 30 provides structure by which the jamb assembly can, if and as desired, be mounted to framing members of the building.

Insert 30 has so far been illustrated as a constant-density, continuous member in all of its length, width, and depth dimensions. However, a wide variety of insert profiles are contemplated, having voids extending along the length of the insert, so long as the stiffening and mounting benefits are provided. Thus, insert 30 can be e.g. an elongate rectangular tube, having 0, 1, 2, 3, or more webs extending between the sides of the insert, at any desired one or more angles to the sides, or at crossing angles relative to the sides.

FIG. 5 shows a cross-section of extended-width casing 62 which, as discussed above, can be received in elongate recess 58 in nosing 26. A spring clip 86, illustrated in more detail in FIGS. 8 and 9, is shown assembled to the casing in FIG. 5. The assembly of the extended-width casing to the nosing is illustrated in FIG. 6. As illustrated in FIG. 5, outer side wall 70B of casing 62 includes an elongate mounting fork 88 having a pair of elongate tines 90 extending along the length of the casing. Each tine has an elongate channel 92 extending along the length of the casing, along the length of the tine, and spaced from a distal edge of the respective tine.

Referring still to FIGS. 5, 8, and 9, spring clip 86 generally defines an “L-shaped” channel 94 having first and second legs 96 which meet at a corner 98. FIG. 8 shows a view from the end of one of the legs of the spring clip. FIG. 9 shows a view from the open-channel side of the spring clip. Referring specifically to FIG. 9, in general, channel 94 extends at a constant cross-section from a first end 100 at one of the legs through corner 98 to a second end 102 at the other of the legs. As viewed in FIG. 8, channel 94 has a top wall 104, and two downwardly-depending side walls 106 which terminate at distal ends 108. Each side wall 106 has an inwardly-projecting ridge 110 which constricts the width of the channel proximate the distal ends of the legs, namely near the open bottom of the channel.

Referring now to FIG. 5, the ridges 110 in the side walls of the spring clip are resiliently received in channels 92 of tines 90 whereby the ridges and channels cooperate in holding the spring clip mounted on the casing. FIG. 12 shows the corner structure of the frame as viewed from inside the building, looking outwardly of the building through the doorway opening which is being framed by frame 18. FIG. 12 shows that the spring clip bridges the corner 111 of frame 18, which is defined between one of the side jamb assemblies and the header jamb assembly.

In the assemblage of a side jamb assembly 20 and a header jamb assembly 22, first and second miter joints are defined at the intersection of side jamb assembly 20A and header jamb assembly 22, and at the intersection of side jamb assembly 20B and header jamb assembly 22. The mitered portion of a side jamb assembly 20 and the mitered portion of header jamb assembly 22 interface with each other and are snugly held in such interfacing relationship by spring clips 86. Accordingly, spring clips 86 control movement of respective ends of header jamb assembly 22 and the corresponding side jamb assembly 20 with respect to each other, in a direction toward and/or away from such building, and/or in a direction generally toward and/or away from the rough opening which extends through the building.

Stated another way, the first and second legs of the spring clip resiliently grip the outwardly disposed edges of the respective mitered ends of the extended casing 62 at the corner defined by a side jamb assembly and the header jamb assembly. Since ridges 110 are at a common distance from top wall 104 on both legs, since channels 92 are located a common distance from outer wall 72 of the casing, the ridges gripping the tines at channels 92 positively seat the respective casings on the header jamb and the side jamb relative to each other such that the outside surfaces of the respective casings are located in a common plane which extends generally parallel to the outer surface of the building. Namely, the spring clip holds the two mitered ends of the casings flush with each other, at a common distance from the outer surface of the building thereby to present the appearance of a single common outer surface on the casings.

Referring to FIG. 6, polymeric, flexible, mounting fin 32 is shown in mounting fin kerf 34 in the nosing, under the extended-width casing. Accordingly, the mounting fin is commonly nailed, or otherwise mounted, to the building framing before the extended casing is installed in recess 58 of the nosing.

As indicated earlier, FIG. 7 illustrates the jamb assembly of FIG. 6 mounted to a double stud building framing structure, exemplarily illustrated as the two adjacent framing members 82, of the building frame using nails 76. The jamb assembly is first mounted to the building framing members 82 by nails or screws 109 through mounting fin 32, spaced along the length of the mounting fin. In addition, the jamb assembly is mounted to the building framing members at the sides of the framing members 82, through insert 30 as shown or, as indicated in dashed outline, through side panels 36A, 36B of the jamb body. FIG. 7 further illustrates weather stripping 112 mounted to the insert by e.g. nails 114, and adapted to interface with a garage door mounted to cooperate with the frame opening. Nails 114 can be inserted through pre-punched or pre-drilled, round or slotted holes 78 in jamb body 24 or insert 30, or can be driven through certain insert materials which have no pre-formed holes but which are susceptible of having nails driven therethrough.

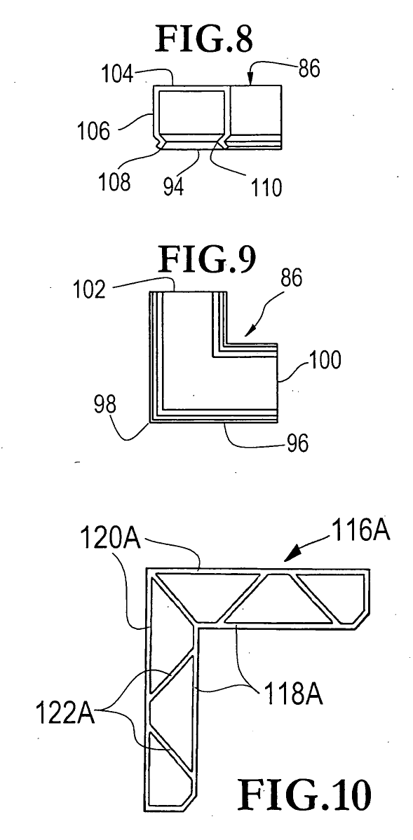

FIG. 10 shows a side elevation view of a corner gusset 116A which is used to join a side jamb assembly 20 to header jamb assembly 22. A such corner gusset is used at each of the corners 111 (FIGS. 1, 11, and 12) at the tops of the respective side jamb assemblies, namely at, for example the miter joints. Gusset 116A includes a pair of legs extending from a common corner. Each leg is defined by an inner panel 118A and an outer panel 120A, and one or more bridging panels 122A which extend as reinforcement members between the inner and outer panels. The inner and outer panels, and the bridging panels, are shown in edge view in FIG. 10. The widths of panels 118A, 120A, 122A extend generally from the outer panel of extruded aluminum jamb body 24 to the inner panel of jamb body 24, thus to extend generally across the entirety of the front-to-rear cross-sectional dimensions of tubular cavity 80, at the opposing ends of the top jamb assembly, and the top ends of the side jamb assemblies.

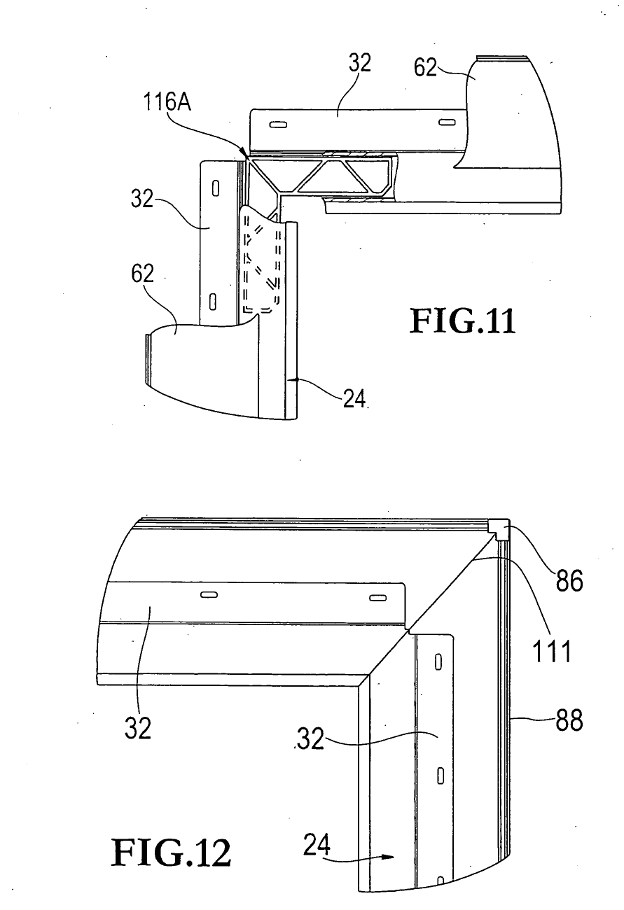

As illustrated in FIGS. 11 and 12, the respective two legs of gusset 116A are received in the respective tubular cavities of the side jamb body and the header jamb body at each of the respective corners 111 of the frame, and extend to the extremities of the tubular cavities along much of the lengths of the legs of the gussets. Chamfers at the ends of the respective legs assist in aligning the legs with the tubular cavities as the gussets are installed in the respective cavities. Gussets 116A thus provide location, guidance, and increased rigidity of the frame, at corners 111.

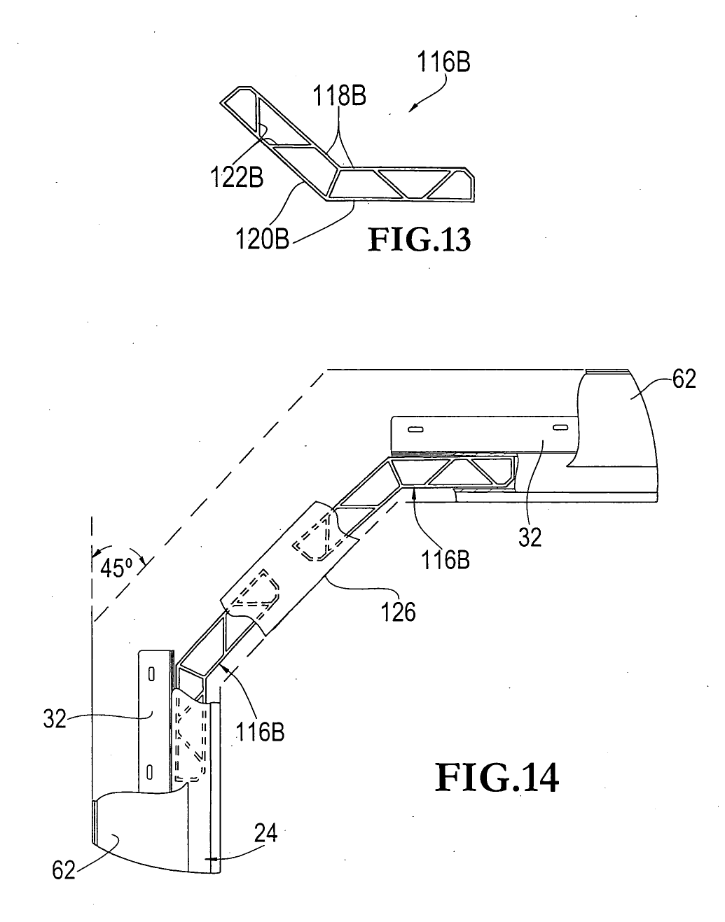

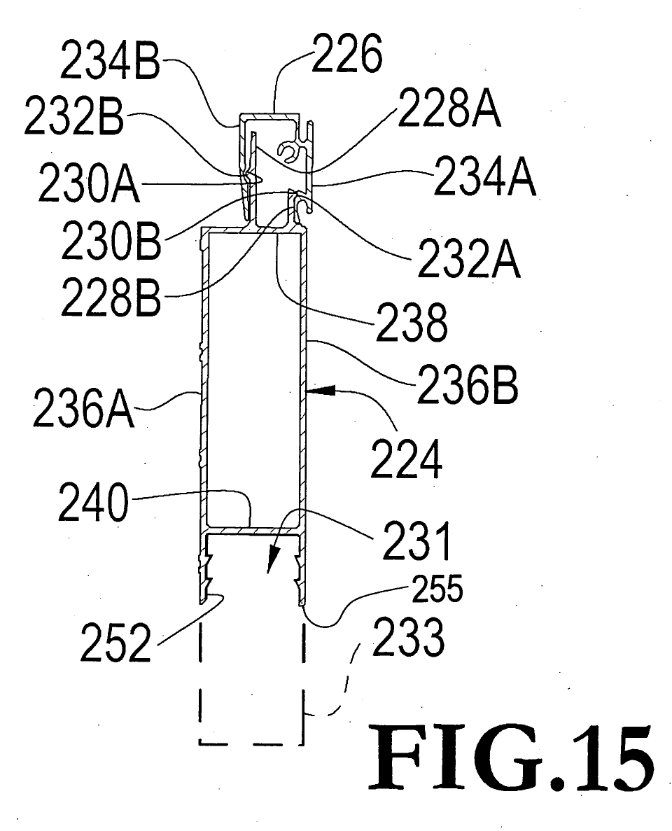

FIG. 13 shows a side elevation view of a second exemplary corner gusset, e.g. corner gusset 116B which is used to join a side jamb assembly 20 to header jamb assembly 22. A pair of such corner gussets is used at each of the corners 111 at the tops of the respective side jamb assemblies and in combination with a cross-member 126 (FIG. 14), namely at, for example, the miter joints. Cross-member 126 can have an extruded profile, the same as that of the respective side jamb or top jamb.

Gusset 116B includes a pair of legs extending from a common corner. Each leg is defined by an inner panel 118B and an outer panel 120B, and one or more bridging panels 122B which extend as reinforcement members between the inner and outer panels.

The inner and outer panels, and the bridging panels, are shown in edge view in FIG. 13, which shows a side elevation view of corner gussets 116B which are used to join a side jamb or a header jamb to angled cross-member 126 at a gusseted corner of the door frame. The widths of panels 118B, 120B, 122B extend generally from the outer panel of the extruded aluminum jamb body 24 to the inner panel of jamb body 24, thus to extend generally across the entirety of the front-to-rear cross-sectional dimensions of tubular cavity 80, at the opposing ends of the top jamb assembly and the top ends of the side jamb assemblies.

As illustrated in FIG. 13, the respective two legs of gusset 116B are received in the respective tubular cavities of the side jamb body and cross-member 126 and/or cross-member 126 and the header jamb body at each of the respective corners of the frame, and generally extend the entirety of at least one dimension of the respective tubular cavities along much of the lengths of the legs of the gusset. Chamfers at the ends of the respective legs assist in aligning the legs with the tubular cavities as the gussets are installed in the respective cavities. Gussets 116B thus provide location, guidance, and increased rigidity of the frame, at the frame corners similar to gussets 116A.

Also as illustrated in FIG. 13, respective ones of inner panels 118B define an angle of about 135 degrees therebetween. Corner gusset 116B thus forms an e.g. 45 degree angle, relative to what would be the projected 90 degree angle (FIG. 14), at the respective corner and is fabricated using inner and outer panels as in gusset 116A, as well as bridging panels. A pair of gussets shown in the corner assembly of FIG. 14 turns the full 90 degree corner, aided by cross-member 126 which is shown in part.

FIG. 15 shows a second embodiment of extruded aluminum jambs 224 of the invention, including a narrow-profile aluminum nosing 226 snap locked to the outer panel of the aluminum jamb extrusion. Mounting structure and/or locking structure, namely legs 228A, 228B, extends outwardly from the outer panel of the jamb extrusion, and snap locks 230A, 230B on legs 228A, 228B engage corresponding snap locks 232A, 232B on respective legs 234A, 234B of the nosing. Jamb 224 extends from outer panel 238 through side panels 236A, 236B to inner panel 240. Rear cavity 231 of jamb 224 extends from inner panel 240 along cavity side walls 252 to the distal ends 255 of the cavity at the ends of side walls 252. Insert 233 is received in cavity 231 much like insert 30 is received in cavity 28.

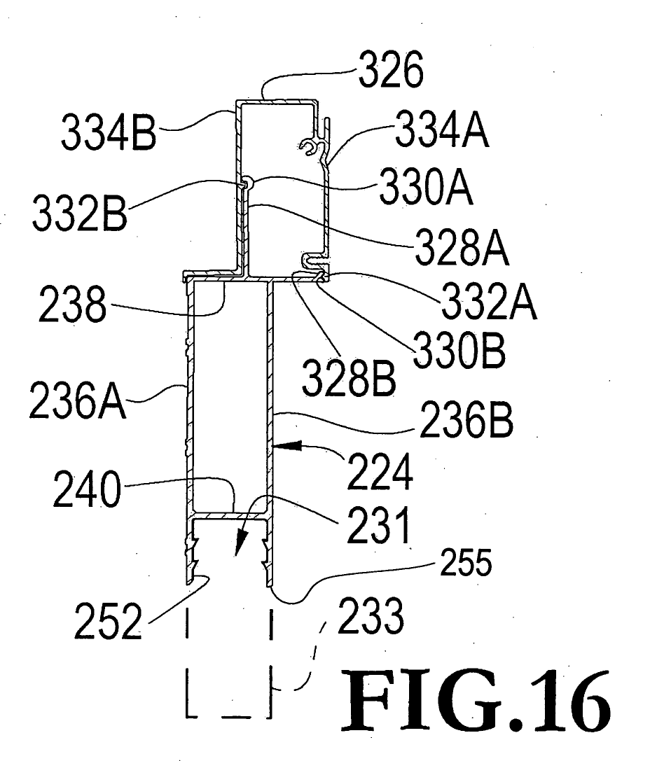

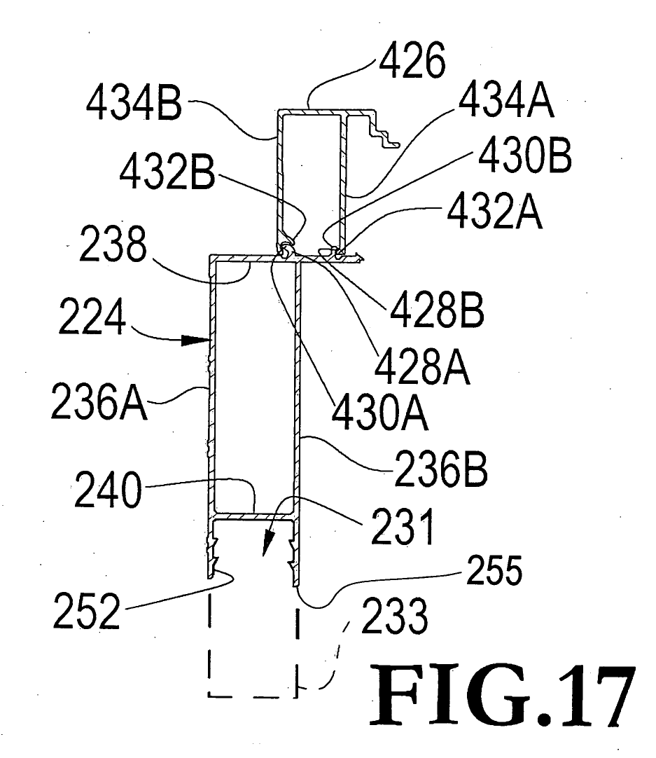

FIG. 16 shows a third embodiment of extruded aluminum jambs of the invention, also including a narrow-profile nosing snap locked to the outer panel of the aluminum jamb extrusion. Namely, the embodiment of FIG. 16 shows yet another embodiment of extruded aluminum jambs of the invention, again including a separate nosing. A durable plastic insert 233 is mounted in rearwardly open, rear cavity 231 in each of the jambs of FIGS. 15 and 16.

As illustrated in FIG. 16, in some embodiments, mounting structure and/or locking structure, namely legs 328A, 328B, extends outwardly from the outer panel of the aluminum jamb extrusion, and snap locks 330A, 330B on legs 328A, 328B engage corresponding snap locks 332A, 332B on respective legs 334A, 334B of the nosing. Jamb 224 extends from outer panel 238 through side panels 236A, 236B to inner panel 240. An outline of rear cavity 231 of jamb 224 extends from inner panel 240 along cavity side walls 252 to the distal ends 255 of the cavity. Insert 233 is received in cavity 231 much like insert 30 is received in cavity 28.

As in the embodiment of FIG. 15, the outer panel of the jamb illustrated in FIG. 16 has first and second legs extending toward the outer wall of the nosing, and the nosing has a pair of legs which extend toward the outer panel of the jamb. In this embodiment, one of the nosing legs also overlies the otherwise-exposed outwardly-facing portion of the outer panel of the jamb. One leg on the outer panel of the jamb is quite short and ends proximate the mounting fin kerf. The other leg on the jamb is substantially longer. Both legs have snap lock structures at the ends of the legs. One of the legs on the nosing has a snap lock for engaging a leg of the jamb at the end of the nosing leg. The other leg of the nosing has a snap lock structure mid-way of the height of the leg between the outer wall of the nosing and the outer panel of the jamb.

FIG. 17 shows another embodiment of extruded aluminum jambs of the invention, including an aluminum nosing snap locked to the outer panel of the aluminum jamb extrusion as in FIGS. 15 and 16. The nosing includes a reverse-brick-mold casing wing. A rigid aluminum mounting fin can be snap locked to the extruded aluminum jamb at the distal end of outer panel 238.

As illustrated in FIG. 17, in some exemplary embodiments, mounting structure and/or locking structure, namely legs 428A, 428B extends outwardly from the outer panel of the jamb extrusion, and snap locks 430A, 430B on legs 428A, 428B engage corresponding snap locks 432A, 432B on respective legs 434A, 434B of the nosing. Jamb 224 extends from outer panel 238 through side panels 236A, 236B to inner panel 240. Cavity 231 in jamb 224 extends from inner panel 240 along cavity side walls 252 to the terminal ends 255 of the cavity. Again, insert 233 is received in cavity 231 much like insert 30 is received in cavity 28.

Thus, FIG. 17 shows still another embodiment of extruded aluminum jambs of the invention, again including a separate nosing. In the embodiment shown in FIG. 17, both legs 430A, 430B extending from the jamb are quite short, such that the legs extend only far enough to form snap locks, wherein the snap locks form substantially the entireties of the legs. Correspondingly, the nosing legs extend substantially the full height of the nosing between the nosing outer wall and the outer panel of the jamb and the nosing locks 432A, 432B are disposed at or near the ends of nosing legs 434A, 434B. The nosing incorporates a casing design extending outwardly from the front wall of the nosing in a generally reverse-design brick mold casing panel. A rigid e.g. aluminum mounting fin can be mounted to the jamb beyond the side panel 236B of the jamb and beyond leg 434A of the nosing. An insert is received in the rear cavity as in FIGS. 15 and 16.

In general, the embodiments of FIGS. 15, 16, and 17 have common design with each other, as well as with the embodiments of FIGS. 4 and 6, when considered from, and excluding, the outer panel of the jamb to the rear end of the insert at terminal ends 255 of cavity side walls 252. Accordingly, the embodiments of FIGS. 15, 16, and 17 differ from each other, and from the embodiments of FIGS. 4 and 6, largely at the outer panel, at the nosing, at the mounting fin, and at the casing. The various alternative structures offered with respect to FIGS. 4 and 6 inwardly of the outer panel can as well be applied to the embodiments of FIGS. 15, 16, and 17.

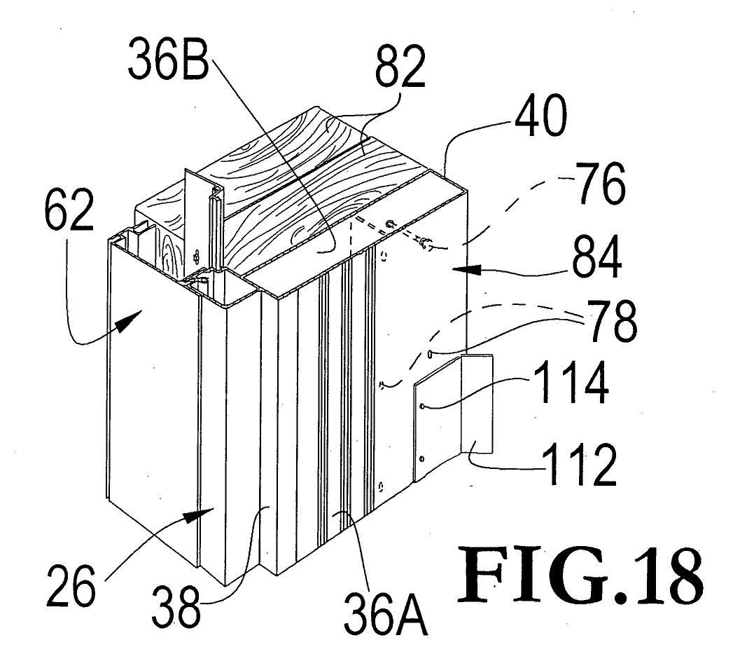

FIG. 18 shows yet another embodiment of jamb assemblies of the invention, which omits insert 30, 233. In such embodiment, the width of jamb side panels 36 is relatively lengthened between outer panel 38 and inner panel 40 such that inner panel 40 is moved to a location nearer the location which had been occupied by the inner surface “IS” (FIG. 7) of the insert. As desired, one or more additional reinforcing webs, one of which is shown in dashed outline in FIG. 18, can be employed to provide additional side-to-side support of the jamb along the depth of tubular cavity 80. Mounting holes 78 are illustrated as being pre-drilled, pre-formed in side panels 36A, 36B so as to facilitate nailing or screwing the jamb to the framing members of the building. As seen in FIG. 18, in this embodiment, the nosing is formed in common with the jamb such that the nosing and the jamb are integral with each other, although the nosing can be a separate element.

For typical use in residential, light commercial, and light industrial implementations, using any of the embodiments of the invention, default jambs have nosing extrusion thicknesses about 0.055 inch thick to about 0.075 inch thick, optionally about 0.065 inch thick. Those skilled in the art can determine and/or adjust the default thicknesses according to intended use of the jamb and tolerance for jamb and/or frame distortion during the expected use life of the jamb and/or frame.

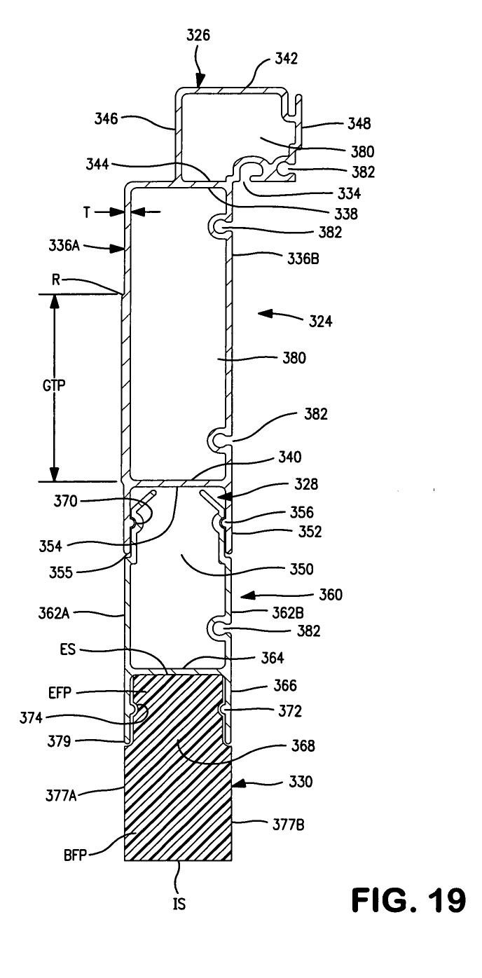

The assembly cross-section shown in FIG. 19 illustrates a jamb assembly similar to the jamb body 24 and integral nosing 26, illustrated in FIG. 2 for use in conventional residential construction such as for a garage door frame or a personnel entry door frame. As in FIG. 2, in FIG. 19, the jamb assembly includes an extruded aluminum jamb body 324, integral with extruded aluminum nosing 326. Jamb 324 further includes rearwardly-disposed, rearwardly-opening rear cavity 328 adapted to receive an insert 330.

Jamb body 324 is generally defined by left 336A and right 336B side panels, outer panel 338, and inner panel 340. In the assembled and installed door frame, the left side panel 336A of the jamb body faces into the doorway opening and right side panel 336B faces the building framing members which define the doorway rough opening. Outer panel 338 of the jamb body faces outwardly of the building and inner panel 340 faces inwardly toward the inside of the building.

Nosing 326 is defined by outer wall 342, inner wall 344, and sides 346, 348. In the embodiment of FIG. 19, the inner wall 344 of the nosing and the outer panel 338 of the jamb body are each defined in part by a common piece of material. Side 346 faces into the doorway opening and is located away from the opening relative to jamb body left side panel 336A.

Rear cavity 328 defines an elongate opening 350 open to the rear of the extruded jamb body and extending along a substantial portion of the length of the jamb body, optionally along substantially the full length of the jamb. Rear cavity 328 in general extends from front wall 354 rearwardly between the inner surface of left and right side walls 352, which are extensions of side panels 336A and 336B to the opening 350 which bridges terminal ends 355 of the cavity side walls. Thus, left and right side walls 352 at least partially define a rearmost portion, e.g. rear, of the extruded aluminum jamb body, including at or adjacent, for example, terminal ends 355 of side panels 336A, 336B which are displaced from the remaining elements of jamb body 324.

Referring to FIG. 2, three spaced pairs of raised ribs 36R are spaced along the depth of jamb side panel 36A. Ribs 36R extend along the length of the extrusion at side panel 36A, thereby reinforcing side panel 36A to reduce the tendency of elongate such side panels 36A, on e.g. a standard height door frame, to undesired waviness along the length of the extruded side panel. However, each rib 36R includes two in-turned angled corners which can collect and hold dirt, which is aesthetically unappealing. The six ribs illustrated have a collective total of 12 such elongate in-turned corners, extending along the length of the extrusion, which can collect and hold dirt.

Returning now to FIG. 19, corresponding side panel 336A extends from outer panel 338 rearwardly at a first default panel thickness “T” such as 0.065 inch, also referred to herein as a lesser thickness portion, to a location “R” corresponding generally to the location where the first pair of ribs 36R are located in the embodiment of FIG. 2. At location “R”, thickness of side panel 336A increases by about 0.015 inch, to a total panel thickness of e.g. about 0.08 inch. Such greater thickness portion “GTP” of side panel 336A extends along the depth of side panel 336A from location “R” to the location where side panel 336A meets inner panel 340 of the jamb, and along the length of the jamb. Such greater thickness portion of side panel 336A provides the level of stiffness/reinforcement of the side panel, and attenuation of waviness, achieved by the ribs in the embodiments of FIG. 2, while reducing, from twelve to two, the number of in-turned corners which can collect and hold dirt, with only a small increase in the weight per length of the resulting jamb. Further, use of only a single increased-thickness portion in place of twelve ribs simplifies the design of the extrusion die. Thus the increased cost of increased mass of aluminum usage in the embodiment of FIG. 19 is at least partially offset by reduced cost of the dies.

In some embodiments, the increase in thickness of the side panel is more gradual, using more rounded changes in panel thickness and thereby generally eliminating the in-turned corners altogether. For example, by making the thickness changes using corner radii of e.g. 0.06 inch, the change in thickness can be accomplished without creating any of the above-mentioned dirt-catching corners.

In order to achieve the waviness attenuation with a single greater thickness portion, the greater thickness portion should extend along at least ¼, optionally at least ⅓, or at least ½, of the depth distance between outer panel 338 and inner panel 340, and should be at least 0.005 inch thicker than the thickness of the lesser thickness portion of the side panel 336A. Such greater thickness increment is determined according to the default thickness of the remaining portions of the side panel, as well as the structural properties of other portions of jamb 324.

Where the default thickness is 0.065 inch, the enhanced thickness portion is typically about 0.015 inch thicker, namely about 0.08 inch total thickness. In general, the enhanced thickness portion is about 10 percent to about 25 percent thicker than the default thickness “T”. Greater thickness increments may be used where the default thickness is less than about 0.065 inch and/or where depth of the enhanced thickness portion is less than about % of the depth of the side panel between the inner panel 340 and the outer panel 338. Where rounded corners are used, more than one, e.g. multiple, greater thickness portions can be used.

While the enhanced thickness portion has been described above, and illustrated in FIG. 19, as being expressed by an outward step in the outer surface of side panel 336A, the same stiffening, reinforcing affect can be achieved by an inward step in the inner surface of side panel 336A while the outer surface is held generally flat between the outer and inner panels 338, 340 of the jamb thus to develop the greater thickness portion. Similarly, both the inner surface and the outer surface can be stepped collectively so as to provide the overall desired incremental increase in thickness of side panel 336A. Also, one surface can be stepped in and the other surface can be stepped out while collectively providing the desired incremental increase in thickness of side panel 336A.

As desired, the enhanced thickness portion “GTP” of side panel 336A can extend the full distance between outer and inner panels 338, 3240, or any lesser but substantial distance, between outer and inner panels 338, 340, which controls waviness in side panel 336A without requiring an overall increase in default thicknesses of the various walls of the jamb.

Still referring to FIG. 19, side walls 352 of cavity 328 extend from front wall 354 rearwardly at the default thickness of about 0.065 inch to protuberances 356, and extend rearwardly of protuberances 356 at reduced thicknesses of about 0.055 inch thus to provide an incremental increase in flexural capability in the portions of legs 352 between protuberances 356 and terminal ends 352. Elongate protuberances 356 extend, in the cavity side walls, along the length of jamb body 324, and extend into the cavity in arcs, generally in constant radius cross-section, of e.g. about 0.045 inch radius, with the centers of the arcs lying generally in the planes defined by the inner surfaces of the cavity side walls between the protuberance and front wall 354. Protuberances 356 in cavity 328 are displaced a substantial distance from front wall 354 of the cavity as well as a substantial distance from distal ends 355 of side walls 352.

While protuberances 356 have been illustrated as generally constant radius cross-section, and generally symmetrical, a wide variety of generally symmetrical configurations are contemplated for the protuberances, such as triangular or trapezoidal protuberances. The inventor has surprisingly found that symmetry of the protuberance configuration facilitates lengthwise sliding of an insert 330, or a depth extender 360, into the cavity.

Returning to FIG. 19, elongate depth extender 360 is shown slidingly inserted/mounted in rear cavity 328. Depth extender 360 has left and right side panels 362A, 362B extending along the length thereof, and from an inner panel 364 to the front of the depth extender adjacent front wall 354 of cavity 328. Side panels 362A, 362B further extend, rearwardly of inner panel 364, as side walls 366 of a rear-facing, rearwardly-opening cavity 368.

Frontwardly-disposed portions of side panels 362A, 362B jog inwardly adjacent terminal ends 355 of side walls 352 of cavity 328 such that side panels 362A, 362B extend along, and closely interface with, the inner surfaces of side walls 352 of the cavity. Such frontwardly-disposed portions of side panels 362A, 362B include recesses 370. Recesses 370 are generally symmetrical, complimentary to protuberances 356, and are cooperatively configured to receive and retain protuberances 356, thereby locking depth extender 360 to jamb body 324 such that depth extender 360 can slide longitudinally with respect to jamb body 324 but cannot slide rearwardly as through opening 350 out of cavity 328.

From inner panel 364, side panels 362A, 362B extend rearwardly at the default thickness of 0.065 inch to generally symmetrical protuberances 372, and extend rearwardly of protuberances 372 at reduced thicknesses of 0.055 inch. As with protuberances 356, elongate protuberances 372 extend along the lengths of the side walls, and into the cavity in circular arcs of 0.045 inch radius, with the centers of the arcs lying in the plane defined by the inner surface of the cavity side wall between the protuberances and inner panel 364. Protuberances 372 are displaced a substantial distance from inner panel 364 of cavity 368 as well as being displaced a substantial distance from distal ends 379 of side walls 366.

While protuberances 372 have been illustrated as being circular and generally symmetrical, as with protuberances 356, a wide variety of generally symmetrical configurations are contemplated for protuberances 372.

Still referring to FIG. 19, insert 330 is received in rear cavity 368. Insert 330 can have any and all of the characteristics described earlier for inserts 30, 233 except for the structures/recesses 374 on the insert, which cooperate with protuberances 372 in mounting the insert to the depth extender at rear cavity 368. In light of the illustrated arcuate and symmetrical protuberances 372, recesses 374 are also desirably arcuate and symmetrical, and extend along the lengths of respective left and right sides 377A, 377B of the insert.

While the protuberances and recesses described with respect to FIG. 19 have been illustrated both as being symmetrical, and as extending along the length of the jamb, the critical feature is that the combination of the protuberances and the recesses acts to automatically generally balance the front-to-rear loading of forces acting between the sides of a recess and the sides of a cooperating protuberance, so as to facilitate lengthwise sliding of the insert into the cavity as the insert is assembled to the depth extender or to rear cavity 328.

In such process, the recesses and protuberances serve as guides in properly positioning the front-to-rear location of the insert relative to the cavity. While such balance of front-to-rear forces is readily illustrated using symmetrical protuberances and recesses, such elements need not necessarily be symmetrical in order to accomplish such balance, whereby non-symmetrical structures are contemplated, to the extent such structures so balance such front-to-rear forces, and thereby provide such improvement in assembly of the insert to the depth extender.

Similarly, the insert can have protuberances cooperating with recesses in the side walls, whereby any cooperating, and balancing, holding structure at the side walls of the cavity and the side walls of the insert can be used to hold the insert in the cavity.

Whether the protuberances are on the insert or on the jamb, the protuberances and recesses collectively generally balance the front-to-rear loading between the insert and the cavity side walls. Within that context, the protuberances can be discontinuous, expressed intermittently, along the length of the jamb or insert. Accordingly, a given protuberance 356, 372, illustrated on each side of the cavity 328, 368 in FIG. 19 represents multiple protuberances arranged along the length of the given side wall 352, 366 of the respective cavity.

Insert 330 is durable, rot resistant, insect resistant, and decay resistant, and can serve as a stiffening member and/or as attachment structure which attaches the insert, and thus the respective jamb assembly, to the building framing members as by nails and/or screws. Insert 330 has an extender-facing portion “EFP” and a building-facing portion “BFP”. Extender facing portion “EFP” of insert 330 generally faces and communicates with depth extender 360, and building facing portion “BFP” of insert 330 generally faces away from the jamb and into the building. A first terminal end surface “ES” of extender facing portion “EFP” is proximate, and/or interfaces with, and/or abuts, and/or otherwise communicates with, an edge or surface, e.g. front wall 364, of cavity 368. A second terminal inner surface “IS” of building facing portion “BFP” faces away from the first terminal end surface “ES” and into the building.

In the embodiment illustrated in FIG. 19, part of the extender facing portion “EFP” of insert 330 has a width dimension of lesser magnitude, between left side wall 377A and right side wall 377B, than the width dimension of the building-facing portion “BFP”. The illustrated difference in the magnitudes of the widths of the extender facing portion corresponds generally to the magnitude of the sum of the thickness dimensions of the left and right cavity side walls 366 adjacent rear ends 379 of the cavity side walls. The width of the extender facing portion “EFP” is generally configured in order to interface with protuberances 372. The building facing portion needs to present a surface at side wall 377B which can interface with the building framing. From side wall 377B, the building facing portion only needs to be thick enough, between side walls 377B and 377A, to satisfy structural requirements related to maintaining the insert in cavity 368 and keeping the jamb mounted securely to the building framing.

Cavity 328 has left-to-right inside dimensions and configuration between side walls 352 which are generally the same as the left-to-right inside dimension and configuration inside cavity 368 of depth extender 360. Similarly, the left-to-right outside configuration of insert 330 is compatible with being inserted into cavity 328 instead of being inserted into depth extender 360, whereby the insert can be used in either cavity 328 or cavity 368, depending on the thickness of the building wall at the doorway rough opening.

The embodiment illustrated in FIG. 19 represents a family of embodiments. Each such embodiment includes an extruded aluminum jamb body 324. The jamb body 324 has the greater thickness portion “GTP” at side panel 336A, or the generally symmetrical protuberances 356, or both.

Typically, jamb body 324 has a frontwardly-disposed generally closed front cavity 380 and a rearwardly-disposed rearwardly-open rear cavity 328.

When insert 330 is disposed in cavity 368, the outer surface of left side wall 377A which extends beyond the cavity side wall 366 can collectively define a generally planar surface e.g. with no substantial change in surface profile height along at least a major portion of the collective surfaces. In the alternative, left side wall 377A can define a narrower segment of the insert rearward of a surface which abuts the left terminal end 379 of the depth extender. Such narrower segment can be defined by a perpendicular angle step change, by an obtuse angle step change, or by a curvilinear change. In any event, where the jamb is mounted to the building framing by driving fasteners through the insert, a portion of left side wall 377A, frontwardly of inner surface “IS” of the insert is optionally parallel to right side wall 377B.

Given the introduction of depth extender 360 as an optional element in the jamb assembly, the depth of jamb body 324, with respect to any of the embodiments of the invention, and not limited to the illustrated embodiments, can be specified according to the thinnest wall thickness contemplated for buildings in which such jambs are intended to be used, and the depth extender is not used in combination with such thinnest walls. Rather, in such thin-wall implementations, insert 330 is e.g. slidingly inserted lengthwise into cavity 328 in the manner illustrated/described with respect to FIGS. 6 and 6A. In relatively thicker-wall implementations, the optional depth extender 360 can be used as illustrated in FIG. 19. Where even thicker wall implementations are encountered, a second, a third, etc. depth extender can be added in serial fashion into the rear cavity 368 of the respective next depth extender; and insert 330 is mounted in the innermost depth extender cavity, referring inwardly into the building.

Referring to the outwardly-facing portion of the jamb assembly as installed in a building, the nosing can be integral as in FIGS. 2, 6, and 19, or can be separate as in FIGS. 15-17, along with appropriate mounting structure on the nosing and on the outer panel e.g. 338 of the jamb. Casings and mounting fins such as those illustrated in FIGS. 3-6, 6A, or others, can be used as desired.

Aluminum extrusions, including but not limited to jamb 24, nosing 26, brick mold casing 60, extended width casing 62, and other extrusions, are preferably extrusions wherein the respective profile elements of the extrusions have nominal default profile thicknesses “T” of about 0.04 inch to about 0.10 inch, with typical thicknesses of about 0.055 inch to about 0.08 inch. A typical general default thickness for walls/panels of a jamb extrusion which is used for residential construction is about 0.065 inch while some portions of the same extrusion can be as much as 0.015 inch, e.g. up to about 25 percent, thinner and other portions of the same extrusion can be as much as 0.015 inch, e.g. up to about 25 percent, thicker. Those skilled in the art are well aware of suitable aluminum alloys and aluminum extrusion processes, e.g. mechanical and/or thermal treatments, and corresponding hardware, e.g. presses, dies, and/or others, to achieve the desired temper, hardness, shape, and/or other properties of the extruded aluminum product.

Insert 30, 233, 330 is desirably sized and configured for a snug fit in cavity 28, 231, 328, 368. Insert 30, 233, 330 can be installed in the cavity by placing the insert alongside the cavity, in the same orientation as shown in e.g. FIGS. 6 and 15, and by then pushing laterally toward front wall 54, 354 of the cavity. Generally, pressure is applied at a first end of the insert pushing the insert into the cavity at a given location along the length of the insert, namely at the end, while correspondingly flexing cavity side walls 52, 252, 352, 366. With the insert installed at the first end, with end surface “ES” proximate the front wall of the cavity, the force is progressively moved along the length of the insert, progressively forcing the insert into the cavity as the lateral force moves along the length of the cavity. Thus a wheel can be used to apply the force at one end of the insert, and the force can be maintained on the wheel, and the insert and jamb moved progressively past the wheel while the wheel continues to apply the lateral pressure, thus to progressively move the insert into the cavity, along the length of the insert. Thus, in the assemblage of insert 30, 233, 330 and jamb body 24, 224, 324, insert 30, 233, 330 is frictionally and/or otherwise mechanically held in cavity 28, 231, 328, 368.

In the alternative, insert 30, 233, 330 can be slidingly inserted into cavity 28, 231, 328, 368 longitudinally along the length of the cavity. As desired, insert 30, 233, 330 and/or the inner surface of side walls 52, 252, 352, 366 and front wall 54, 354, 364 of cavity 28, 231, 328, 368 can be lubricated with e.g. wet or dry lubricant to facilitate such sliding insertion.

In some embodiments, a side jamb assembly 20 includes a plurality of jamb components in vertical alignment with each other, e.g. “stacked” serially on top of each other. Namely, side jamb assembly 20 can include an upper member and a lower member. The upper member has a length, and defines at least one cavity which extends along its length. The lower member defines an insert portion received into the cavity of the upper member and an extension portion which is made of a durable rot and decay resistant material. The extension portion extends downwardly from the lower edge of the upper member to a lower end of the lower member a distance sufficient to substantially avoid travel of liquid water, by surface tension, from the lower end of the lower member to a lower end of the upper member. Exemplary lengths of extension of the extension portion include at least about two inches, at least about four inches, at least about six inches, at least about ten inches, at least about twenty inches, at least about thirty inches, whereby any water at the lower end of the lower member is unable to travel by capillary-action wicking to the lower end of the upper member.

Insert 30, 233, 330 has been described and illustrated as a solid piece, e.g. polymeric piece, or piece of treated wood. In the alternative, and especially where the insert includes a polymeric matrix, the amount of material used in the insert can be reduced so long as sufficient structural integrity of the insert is maintained. For example, a limited amount of air can be incorporated into the insert such as by forming the insert as a high-density foam of e.g. greater than 20 pounds per square foot (psf) density, optionally greater than 35 psf so as to save on material costs while preserving sufficient strength and rigidity in the insert to perform the functions desired to be attributable to the insert. Another way of reducing material usage in the insert is to fabricate the insert with a hollow central portion, such as an e.g. hollow tube.

Insert 30, 233, 330 can be fabricated using e.g. conventional extrusion processes which generally soften/melt/plasticize the polymeric composition and push/extrude the polymeric material out of the processing equipment through an extrusion die.

In the alternative, insert 30, 233, 330 can be fabricated using pultrusion processes which generally soften/melt/plasticize the polymeric composition, and use the softened/melted/plasticized polymeric composition to saturate and coat reinforcing e.g. fiberglass fibers which are being pulled through the processing equipment.

To install the door frame, the rough opening must first be “framed into” the building/structure. Such framing is typically done by the carpenter, and/or other onsite worker who is building the building/structure, and is not typically done by the door installer. Namely, the onsite worker installs appropriate header and trimmer studs, such as framing members 82, sufficiently strong and durable to support the span of the rough opening, and the door to be installed therein.

The door installer installs the door and/or corresponding door frame. The installer may install the frame as separate components in sequence, e.g. side jamb assemblies 20 (which may or may not include nosing 26), header jamb assembly 22, brick mold casing 60 or extended width casing 62, and/or others. In the alternative, the installer can pre-assemble the frame, optionally including a door slab for a personnel entry door, on site or at a remote location, and “tip” the assembly into the building rough opening and subsequently secure the assembly to e.g. the framing members of the building.

In the embodiment illustrated in FIG. 19, a plurality of screw bosses 382 are located on jamb 324, nosing 326, and depth extender 360, on the sides of the respective elements which face away from the doorway opening. Screw bosses 382 facilitate the joining of the side jambs and the header jamb to each other when the respective jambs are joined in making a frame assembly. Specifically the screw bosses on a side jamb assembly are aligned, at the respective e.g. 90 degree angle where the side jamb assembly meets the header jamb assembly in a door frame. Aligning the screw bosses on the side and header jamb assemblies brings the elements of the header jamb assembly into alignment with the corresponding elements of the side jamb assembly, thus to properly position the side jamb assembly and the header jamb assembly for the joinder necessary in assembling the door frame.

Screws are then advanced through the screw bosses in the header jamb assembly into the corresponding screw bosses in the side jamb assembly, thus to draw and secure the side jamb assembly to the header jamb assembly. In the alternative, screws are advanced through the screw bosses in the side jamb assembly into the corresponding screw bosses in the header jamb assembly, thus to draw and secure the header jamb assembly to the side jamb assembly.

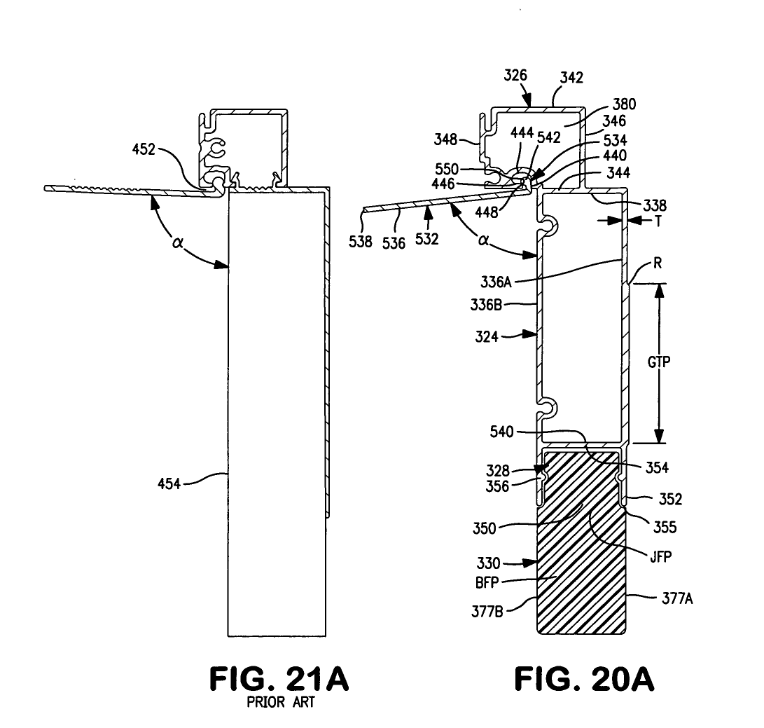

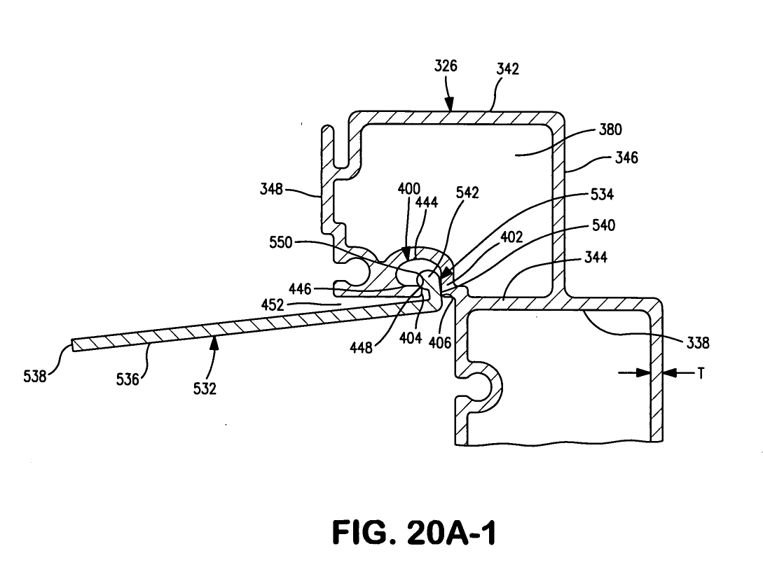

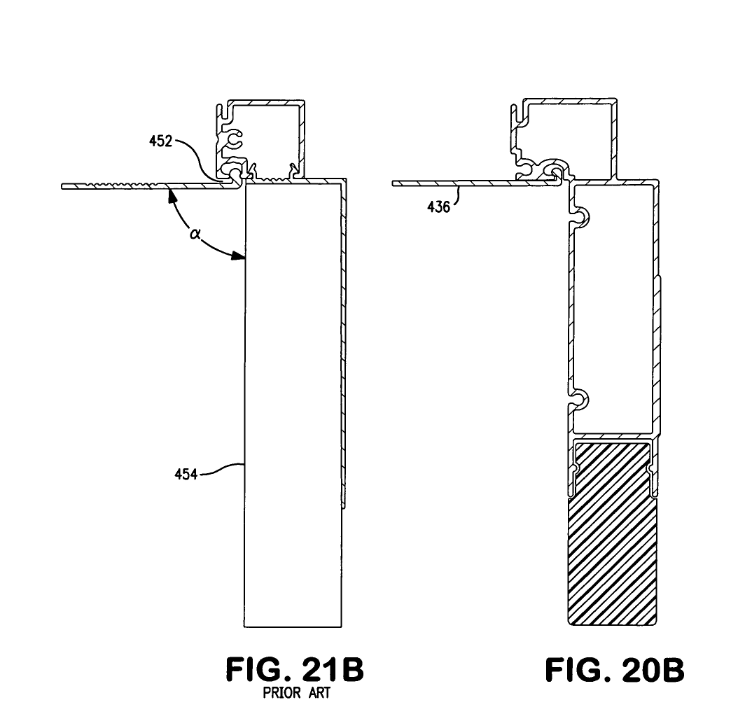

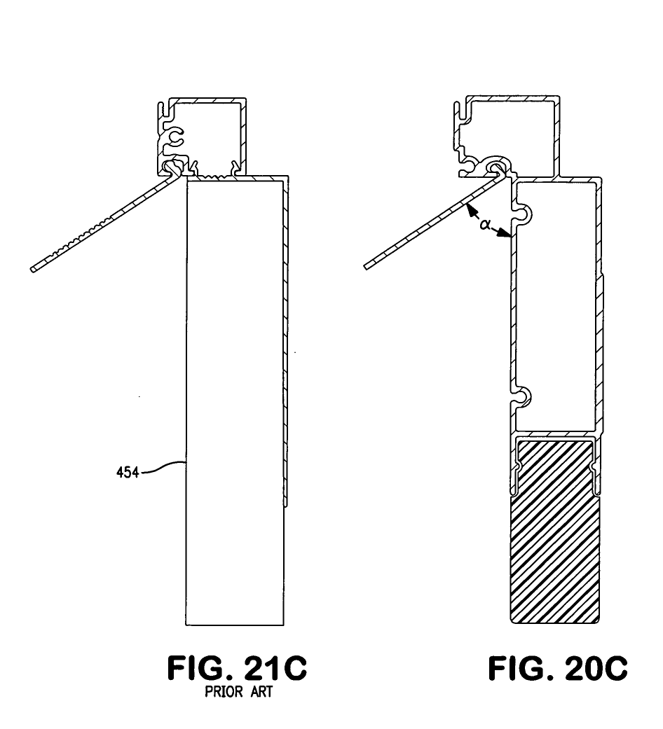

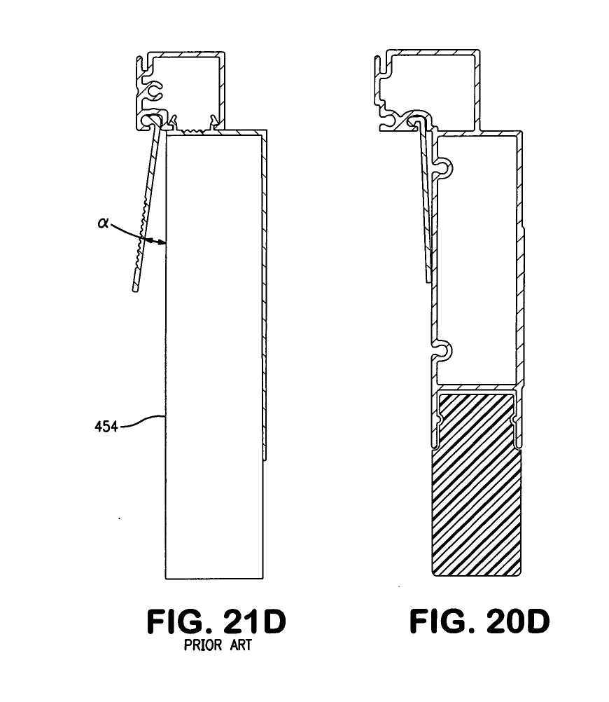

FIGS. 21A-21D illustrate a prior art jamb assembly in 4 stages of erection/retraction of the mounting fin relative to the jamb body. FIGS. 20A-20D illustrate jamb assemblies of the invention in corresponding 4 stages of erection/retraction of the mounting fin relative to the jamb body. All of FIGS. 20A-20D and 21A-21D assume that the inner surface (IS) of a given jamb assembly is resting on a horizontal surface and that the nosing is at the highest elevation of any portion of the jamb assembly, whereby gravity is pulling toward the inner surface (IS).

FIGS. 20A and 21A illustrate the respective mounting fins in the erected and locked orientation. FIGS. 20B and 21B illustrate the respective mounting fins as unlocked and still erect. In both FIGS. 20B and 21B, the fin requires external support to hold the fin in the positions shown. Thus, the illustrated orientations, unlocked, are not stable and will be transitory if the fins are not supported e.g. by a user's hand or otherwise. FIGS. 20C and 21C illustrate the respective mounting fins after the fins have been unlocked, after external support has been removed, and while the fins are rotating downwardly in response to the pull of gravity. FIGS. 20D and 21D illustrate the respective mounting fins after the fins have rotated as far downwardly, according to the pull of gravity, as they can go, and wherein the fins have been further urged against the jamb body by an external force such as the user's hand.

The cross-section illustrated in FIG. 20A shows the extruded aluminum jamb body 324 and nosing 326 combination of FIG. 19 in mirror image representation, wherein the nosing is integral with the jamb body. For numbering purposes, the same numbers are used in FIG. 20A to represent the same elements as in FIG. 19. Given that FIBURE 20A is a mirror image of FIG. 19, the left/right nomenclature used in FIG. 20A, while consistent with the elements in FIG. 19, appears to be incorrect until the mirror image affect is taken into account. Thus, for example, a left panel in FIG. 19 appears on the right side of the drawing in FIG. 20A.

The embodiment of FIG. 20A does not include depth extender 360 whereby insert 330 is mounted directly in rear cavity 328.

As in FIG. 19, jamb body 324 is generally defined by left 336A and right 336B side panels, outer panel 338, and inner panel 340. In the assembled and installed door frame, the left side panel 336A of the jamb body faces into the doorway opening and right side panel 336B faces the building framing members which define the doorway rough opening. Outer panel 338 of the jamb body faces outwardly of the building and inner panel 340 faces inwardly toward the inside of the building.

Nosing 326 is defined by outer wall 342, inner wall 344, and sides 346, 348. Inner wall 344 of the nosing and the outer panel 338 of the jamb body are each defined in part by a common piece of material. Side 346 faces into the doorway opening and is located away from the opening relative to jamb body left side panel 336A.

Rear cavity 328 defines an elongate opening 350 open to the rear of the extruded jamb body and extending along a substantial portion of the length of the jamb body, optionally along substantially the full length of the jamb. Rear cavity 328 in general extends from front wall 354 rearwardly between the inner surface of left and right side walls 352, which are extensions of side panels 336A and 336B to the opening 350 which bridges terminal ends 355 of the cavity side walls. Thus, left and right side walls 352 at least partially define a rearmost portion, e.g. rear, of the extruded aluminum jamb body, including at or adjacent, for example, terminal ends 355 of side panels 336A, 336B which are displaced from the remaining elements of jamb body 324.

As in FIG. 19, side panel 336A extends from outer panel 338 rearwardly at a first default panel thickness “T” such as 0.065 inch, also referred to herein as a lesser thickness portion, to a location “R” corresponding generally to the location where the first pair of ribs 36R are located in the embodiment of FIG. 2. At location “R”, thickness of side panel 336A increases by about 0.015 inch, to a total panel thickness of e.g. about 0.08 inch. Such greater thickness portion “GTP” of side panel 336A extends along the depth of side panel 336A from location “R” to the location where side panel 336A meets inner panel 340 of the jamb, and along the length of the jamb. As in the embodiment of FIG. 19, such greater thickness portion of side panel 336A provides the level of stiffness/reinforcement of the side panel, and attenuation of waviness, achieved by the ribs in the embodiments of FIG. 2, while reducing, from twelve to two, the number of in-turned corners which can collect and hold dirt, with only a small increase in the weight per length of the resulting jamb. The various advantages and benefits, as well as various embodiments, of the greater thickness portion are the same as those discussed with respect to FIG. 19.

Side walls 352 of cavity 328 extend from front wall 354 rearwardly at the default thickness of about 0.065 inch to protuberances 356, and extend rearwardly of protuberances 356 at reduced thicknesses of about 0.055 inch thus to provide an incremental increase in flexural capability in the portions of legs 352 between protuberances 356 and terminal ends 352. Elongate protuberances 356 extend, in the cavity side walls, along the length of jamb body 324, and extend into the cavity in arcs, generally in constant radius cross-section, of e.g. about 0.045 inch radius, with the centers of the arcs lying generally in the planes defined by the inner surfaces of the cavity side walls between the protuberance and front wall 354. Protuberances 356 in cavity 328 are displaced a substantial distance from front wall 354 as well as a substantial distance from distal ends 355.

While protuberances 356 have been illustrated as generally constant radius cross-section, and generally symmetrical, a wide variety of generally symmetrical configurations are contemplated for the protuberances, such as triangular or trapezoidal protuberances. The inventor has surprisingly found that symmetry of the protuberance configuration facilitates lengthwise sliding of an insert 330, or a depth extender 360, into the cavity.

Still referring to FIG. 20A, insert 330 is received in rear cavity 328. Insert 330 can have any and all of the characteristics described earlier for inserts 30, 233 except for the structures/recesses 374 on the insert, which cooperate with protuberances 372 in mounting the insert to the depth extender at rear cavity 368. In light of the illustrated arcuate and symmetrical protuberances 372, recesses 374 are also desirably arcuate and symmetrical, and extend along the lengths of respective left and right sides 377A, 377B of the insert.

While the protuberances and recesses described with respect to FIG. 20A have been illustrated both as being symmetrical, and as extending along the length of the jamb, the critical feature is that the combination of the protuberances and the recesses acts to automatically generally balance the front-to-rear loading of forces acting between the sides of a recess and the sides of a cooperating protuberance, so as to facilitate lengthwise sliding of the insert into the cavity as the insert is assembled to rear cavity 328.

In such process, the recesses and protuberances serve as guides in properly positioning the front-to-rear location of the insert relative to the cavity. While such load balancing, of front-to-rear forces, is readily illustrated using symmetrical protuberances and recesses, such elements need not necessarily be symmetrical in order to accomplish such balance, whereby non-symmetrical structures, for both the recesses and the protuberances are contemplated, to the extent such structures so balance such front-to-rear forces, and thereby provide such improvement in assembly of the insert to the depth extender.

Similarly, the insert can have protuberances cooperating with recesses in the side walls of the jamb body, whereby any cooperating, and balancing, holding structure at the side walls of the cavity and the side walls of the insert can be used to hold the insert in the cavity.

Whether the protuberances are on the insert or on the jamb body, the protuberances and recesses collectively generally balance the front-to-rear loading between the insert and the cavity side walls. Within that context, the protuberances can be discontinuous, expressed intermittently, along the length of the jamb or insert. Accordingly, a given protuberance 356, illustrated on each side of the cavity 328 in FIG. 20A represents multiple protuberances arranged along the length of the given side wall 352 of the cavity.

Insert 330 is durable, rot resistant, insect resistant, and decay resistant, and can serve as a stiffening member and/or as attachment structure which attaches the insert, and thus the respective jamb assembly, to the building framing members as by nails and/or screws. Insert 330 has an building-facing portion “BFP” and a jamb-facing portion “JFP”. Jamb-facing portion “JFP” of insert 330 generally faces and communicates with jamb body 324, and building-facing portion “BFP” of insert 330 generally faces away from the jamb and into the building. A first terminal end surface “ES” of jamb-facing portion “JFP” is proximate, and/or interfaces with, and/or abuts, and/or otherwise communicates with, an edge or surface, e.g. front wall 354, of cavity 328. A second terminal inner surface “IS” of building facing portion “BFP” faces away from the first terminal end surface “ES” and into the building.

In the embodiment illustrated in FIG. 20A, part of the jamb-facing portion “JFP” of insert 330 has a width dimension of lesser magnitude, between left side wall 377A and right side wall 377B, than the width dimension of the building-facing portion “BFP”. The illustrated difference in the magnitudes of the widths of the extender facing portion corresponds generally to the magnitude of the sum of the thickness dimensions of the left and right cavity side walls 352 adjacent terminal ends 355 of the cavity side walls. The width of the jamb-facing portion “JFP” is generally configured in order to interface with protuberances 356. The building facing portion needs to present a surface at side wall 377B which can interface with the building framing. From side wall 377B, the building-facing portion only needs to be thick enough, between side walls 377B and 377A, to satisfy structural requirements related to maintaining the insert in cavity 328 and keeping the jamb mounted securely to the building framing.

The embodiment illustrated in FIG. 20A represents a family of embodiments. Each such embodiment includes an extruded aluminum jamb body 324. The jamb body 324 has the greater thickness portion “GTP” at side panel 336A, or the generally symmetrical protuberances 356, or both.

Typically, jamb body 324 has a frontwardly-disposed generally closed front cavity 380 and a rearwardly-disposed rearwardly-open rear cavity 328.

When insert 330 is disposed in cavity 328, the outer surface of left side wall 377A which extends beyond the cavity side wall 352 can collectively define a generally planar surface e.g. with no substantial change in surface profile height along at least a major portion of the collective surfaces. In the alternative, left side wall 377A can define a narrower segment of the insert rearward of a surface which abuts the left terminal end 355 of the cavity side wall 352. Such narrower segment can be defined by a perpendicular angle step change, by an obtuse angle step change, or by a curvilinear change in side wall 377A. In any event, where the jamb is mounted to the building framing by driving fasteners through the insert, a portion of left side wall 377A, frontwardly of inner surface “IS” of the insert is optionally parallel to right side wall 377B.

Referring to the outwardly-facing portion of the jamb assembly as installed in a building, the nosing can be integral as in FIGS. 2, 6, 19, and 20A-20D, or can be separate as in FIGS. 15-17 along with appropriate mounting structure on the nosing and on the outer panel e.g. 338 of the jamb.

Turning now to the kerf 334 shown in FIG. 20A, and in expanded view in FIG. 20A-1, as in prior art FIG. 21A, the kerf has a generally boot-shaped cross-section, defining an inwardly-disposed foot portion 400, and an ankle-shaped cross-section 402 at the heel end of the foot portion. The ankle-shaped cross-section has a toe side 404 disposed toward the toe of the foot portion and a heel side 406 disposed toward the heel of the foot portion. The heel side of the slot-shaped cross-section extends from the foot portion to the outside ambient environment along a generally straight line.

Still referring to FIGS. 20A and 20A-1, mounting fin 532 has a base portion 534 and an extension portion 536 which extends from the base portion to a distal edge 538. A cross-section of base portion 534, as illustrated in FIGS. 20A and 20A-1, extends as a generally constant-thickness leg 540, generally the same thickness as extension portion 536, at a perpendicular angle, and in a straight line, from extension portion 536 to an enlarged bulbous portion 542. Foot portion 400 of the kerf has a sole side 444 and an arch side 446 extending to an arch side end 448 portion.

Base portion 534 defines a cross-section which is generally straight or convex from the joinder of the base portion with the fin extension portion, on the heel side of leg 540, about the ankle and the bulbous portion, to the toe side of the leg portion.

The locking structure of the base portion is represented by the outer surface which extends from the heel side of leg 540 where the leg joins the fin extension portion, about the bulbous portion, to the toe side of leg 540. The locking structure is sized and configured such that, when the extension portion 536 of the fin is elevated as illustrated in FIGS. 20A and 20A-1, and then released to the downward pull of gravity, end 550 of the bulbous portion wedges against end 448 of the arch side end of the foot portion, while the heel side of the straight portion of leg 540 wedges against straight heel side 406 of the ankle-shaped slot opening. With both sides of base portion 534 wedged against opposing sides of the ankle-shaped cross-section of the kerf opening, the fin is locked against further downward rotation of the fin. FIGS. 20A and 20A-1 illustrate that, when the fin is so locked in the erected orientation, the extension portion of the fin defines an angle α, with jamb side panel 336B, of about 75 degrees to about 90 degrees, but can be readily lifted to a greater angle α.

In the locked orientation illustrated in FIGS. 20A and 20A-1, and with the fin extension portion defining an angle α of about 75-90 degrees, there is an unoccupied space 452 between fin extension 536 and nosing 326. Space 452 extends from nosing side 348 to kerf 334 and to the toe side of leg 540, with a space between arch side end 448 and the toe side of leg 540.

With the fin so erected and locked against downward rotation, the fin can be released from its locked orientation and rotated either upwardly or downwardly by pulling the fin generally perpendicularly away from jamb side panel 336B. FIG. 20B shows the fin after the fin has been pulled away from panel 336B. As the fin is pulled away from panel 336B, the bulbous end rides up onto the arch side end, and the heel side of the leg moves away from the heel side of the ankle-shaped portion of the kerf, thus releasing the wedging actions which exist when the fin is locked in the erect orientation.

With the fin thus released from the locked condition, with the bulbous portion confined entirely within the foot-shaped portion of the kerf, the fin is free to rotate downwardly toward the retracted orientation. FIG. 20C illustrates this condition, with an angle α of about 55 degrees between extension 436 and panel 336B. FIG. 20D illustrates the fin fully retracted, with the distal edge of the fin disposed against panel 336B, and wherein the angle α defines an angle slightly beyond a downward vertical angle, which may be thought of as a negative angle relative to panel 336B.

Being able to lock the fin in the erect orientation is important in that the door frame is most easily tipped into the rough opening of the building when the fins on the respective jambs are erected, thus generally positioned to lie against the outer sheathing of the building when the door frame is tipped into the opening. However, it is important that the fin be readily released from the locked orientation in order that the fin lie freely against the sheathing for nailing, or screwing, or other securement of the fin to the sheathing or building framing.

By contrast, the corresponding structure of the base portion in FIG. 21A includes concave sections of the base portion on both the heel side of the base portion and the toe side of the base portion. A protuberance on the heel side of the ankle-shaped slot cooperates with the heel-side concave section on the base portion of the fin. The end of the arch side of the foot portion cooperates with the toe-side concave section on the base portion of the fin. Thus, in the prior art illustrated in FIG. 21A, portions of the kerf structure project into concave sections of the base portion of the fin, on both sides of the fin base portion, to lock the fin in the erect orientation. FIG. 21A illustrates that the angle α in the erected orientation is greater than 90 degrees, namely about 95 degrees, whereby it is critical that the fin be unlocked before the fin is secured to the building framing/sheathing.

As in the invention, in the erected orientation of prior art FIG. 21A, there is an unoccupied space 452 between the extension portion of the fin and the nosing. Contrary to the invention, in the prior art, the fin is unlocked by lifting, and sometimes by also pulling on, the fin at the base portion. FIG. 21B illustrates the fin when the fin is thus unlocked, the fin has moved into space 452, the heel side concavity has been released from the heel side projection, and the bulbous portion has been elevated entirely into the foot-shaped portion of the cavity. The fin is then free to rotate downwardly toward the substrate 454 as illustrated in FIGS. 21C and 21D. FIG. 21D illustrates the full extent of the capability of the fin to rotate toward the substrate. In FIG. 21D, angle α is about 10 degrees. Further rotation of the fin toward the substrate is precluded by the protuberance on the heel side of the slot-shaped opening of the kerf. Thus, in the prior art embodiments of FIGS. 21A-21D, the fin cannot be fully retracted against the substrate for shipping, whereas in the invention the fin can be fully retracted as illustrated in FIG. 20D.

Whereas, in the invention, the fin can be unlocked by merely pulling on the fin, in the prior art illustrated in FIGS. 21A-21D, the fin must be lifted and sometimes pulled. Since such “lifting” only takes place after the door frame is tilted into the rough opening, the building framing prevents effective manipulation of the fin for such releasing, whereby release of fins of the prior art can be problematic at the installation site. Yet since the erected angle is greater than 90 degrees, the fin must be released.

By contrast, in the invention, the angle of the erected fin is no more than 90 degrees. Because the erected angle is no more than 90 degrees, and since the fin can readily be raised to a 90 degree angle, when the door frame is tipped into the rough opening, the fin angle automatically adjusts itself upwardly as the frame is brought into contact with the building framing/sheathing, to that angle which positions the fin flat against the building framing/sheathing. In the event the fin is to be retracted, the fin is readily unlocked by simply pulling outwardly on the fin.

For any material which uses polymeric ingredients in substantial portion, in structures of the invention, any conventional additive package can be included such as, for example and without limitation, slip agents, anti-block agents, release agents, anti-oxidants, fillers, fiber reinforcements, and/or plasticizers, to control e.g. processing of the polymeric material as well as to stabilize and/or otherwise to control the properties of the finished processed product, also to control hardness, bending resistance, and the like.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A door jamb, having a length, and being adapted to be received, as part of a door frame, into a rough opening in a building, said door jamb comprising:
(a) a jamb body having a length and comprising
(i) a first side facing toward such rough opening,
(ii) a second side facing away from such rough opening,
(iii) an outer side facing outwardly of such building, and
(iv) an inner side facing inwardly into such building;
(b) a nosing, attached to said jamb body and extending outwardly of said building, away from said outer side of said jamb body, said nosing having a length; and
(c) a single elongate mounting fin kerf extending along the length of said nosing, said elongate mounting fin kerf having a boot-shaped cross-section defined by an inwardly-disposed foot portion having a generally foot-shaped cross-section, said foot portion having a toe end and a heel end, said kerf further comprising a slot-shaped opening portion having an ankle-shaped cross-section at the heel end of the foot portion, said slot-shaped opening portion leading from the foot portion out of the kerf and into outside ambient environment, the slot-shaped opening portion having a toe side and a heel side, the heel side of said slot-shaped opening portion extending from the foot portion to the outside ambient environment along a generally straight line.

2. A door jamb assembly comprising a door jamb as in claim 1, and an elongate generally rigid mounting fin in the kerf, said mounting fin having a base portion received in the kerf, and a distal side remote from said base portion, said mounting fin being movable to a retracted orientation wherein the distal side of said mounting fin is located generally proximate the second side of said jamb body, and being movable to an erected orientation wherein the distal side is displaced from the second side of said jamb body,
and wherein said mounting fin can be locked in the erected orientation by interference between
(i) said base portion of said mounting fin and
(ii) said heel side wall and said toe side wall of said mounting fin kerf,
said mounting fin, when so locked in said kerf, in the erected orientation, defining a minimum angle of about 75 degrees to about 90 degrees with respect to the second side of said jamb body.

3. A door jamb assembly as in claim 1, said jamb body comprising an aluminum extrusion having a plurality of panels defining the first side, the second side, the outer side, and the inner side, which plurality of panels collectively have an overall average panel thickness of about 0.055 inch to about 0.075 inch.

4. A door jamb assembly as in claim 1, said jamb body comprising an aluminum extrusion having a plurality of panels defining the first side, the second side, the outer side, and the inner side, at least one of said panels having a first lesser thickness portion about 0.04 inch thick to about 0.10 inch thick, and at least one of said panels having a second greater thickness portion which is about ten percent to about twenty-five percent thicker than the first lesser thickness portion.

5. A door jamb assembly as in claim 1, said jamb body comprising an aluminum extrusion having a plurality of panels defining the first side, the second side, the outer side, and the inner side, further comprising a rear-opening cavity disposed rearwardly in said door jamb assembly, an insert being disposed in the rear-opening cavity, said insert having an end surface (ES) facing, and proximate, the inner side.

6. A door jamb assembly as in claim 1, the first and second sides comprising respective first and second side panels, further comprising a rear-opening cavity disposed relatively rearwardly in said jamb body of the inner side and extending along the length of said jamb body, said rear-opening cavity being defined in part by extensions of said first and second side panels rearwardly from said inner side, further comprising an insert in the cavity, said insert having first and second side walls, recesses and protuberances collectively disposed in said extensions of said first and second side panels of said jamb body, and in said first and second side walls of said insert, cooperating with each other thereby to hold said insert in the rear-opening cavity, and wherein said first and second side panels of the cavity have terminal ends (355), and wherein said insert extends rearward of said terminal ends (355) and outwardly of the cavity.

7. A door jamb assembly as in claim 1, further comprising an elongate generally rigid mounting fin in the kerf, said mounting fin having a base portion and a distal side,
(i) said mounting fin being movable to, and lockable in, an erected orientation wherein the distal side of said mounting fin is displaced from the second side of said jamb body, and
(ii) said mounting fin being adapted to be unlocked from the erected orientation and moved to a retracted orientation wherein a portion of said mounting fin can lie against the second side of said jamb body.

8. A door jamb assembly as in claim 1, further comprising an elongate generally rigid mounting fin in the kerf,
(i) said mounting fin being movable to, and lockable in, an erected orientation wherein a distal side of said mounting fin is displaced from the second side of said jamb body, and
(ii) said mounting fin being adapted to be unlocked from the erected orientation and rotated toward the second side of said jamb body,
the unlocking of said mounting fin from the erected and locked orientation being effected by pulling said mounting fin in a direction generally perpendicularly away from the second side of said jamb body.

9. A door frame assembly made using left and right door jambs as in claim 1 in combination with a header jamb.

10. A door jamb assembly as in claim 1 wherein said jamb body comprises an extruded aluminum door jamb.

11. A door jamb assembly as in claim 1, comprising a jamb substrate, and an extruded aluminum jamb cover mounted over said jamb substrate, said nosing being integral with or mounted on said jamb cover.

12. A door jamb assembly, having a length, and being adapted to be received, as part of a door frame, into a rough opening in a building, said door jamb assembly comprising:
(a) a jamb body having a length, and comprising
(i) a first side facing toward such rough opening,
(ii) a second side facing away from such rough opening,
(iii) an outer side facing outwardly of such building, and
(iv) an inner side facing inwardly into such building;
(b) a nosing attached to said jamb body and extending outwardly of said building, away from said outer side of said jamb body, said nosing having a length;
(c) a single elongate mounting fin kerf extending along the length of said nosing, said mounting fin kerf having a slot-shaped opening defined by a heel side wall and a toe side wall; and
(d) an elongate generally rigid mounting fin in the kerf, said mounting fin having a base portion received in the kerf, and a distal side remote from said base portion, said mounting fin being
(i) movable to a retracted orientation wherein the distal side of said mounting fin is located generally proximate the second side of said jamb body, and
(ii) movable to an erected orientation wherein the distal side is displaced from the second side of said jamb body,
and wherein said mounting fin can be locked in the erected orientation by interference between
(i) said base portion of said mounting fin and
(ii) said heel side wall and said toe side wall of said mounting fin kerf,
said mounting fin, when so locked in said mounting fin kerf, in the erected orientation, defining a minimum angle of about 75 degrees to about 90 degrees with respect to the second side of said jamb body.

13. A door jamb assembly as in claim 12, said mounting fin, when so locked in said mounting fin kerf, in the erected orientation, defining a minimum angle of about 80 degrees to about 90 degrees with respect to the second side of said jamb body.

14. A door jamb assembly as in claim 12 wherein the combination of said kerf and said base portion of said mounting fin are adapted such that said mounting fin can be unlocked from the erected orientation by pulling said mounting fin in a direction generally perpendicularly away from the second side of said jamb body.

15. A door jamb assembly as in claim 12, said single elongate mounting fin kerf having a boot-shaped cross-section defined by an inwardly-disposed foot portion having a generally foot-shaped cross-section having a toe end and a heel end, the slot-shaped opening being located proximate the heel end of the foot portion and having an ankle-shaped cross-section, the heel side wall of the slot-shaped opening extending from the heel end of the foot portion to the outside ambient environment along a generally straight line.

16. A door jamb assembly as in claim 12, said jamb body comprising an aluminum extrusion having a plurality of panels defining the first side, the second side, the outer side, and the inner side, which plurality of panels collectively have an overall average panel thickness of about 0.055 inch to about 0.075 inch.

17. A door jamb assembly as in claim 12, said jamb body comprising an aluminum extrusion having a plurality of panels defining the first side, the second side, the outer side, and the inner side, at least one of said panels having a first lesser thickness portion about 0.04 inch thick to about 0.10 inch thick, and at least one of said panels having a second greater thickness portion which is about ten percent to about twenty-five percent thicker than the first lesser thickness portion.

18. A door jamb assembly as in claim 12, the first side comprising a first side panel, the second side comprising a second side panel, the outer side comprising an outer side panel, and the inner side comprising an inner panel, said jamb body further comprising a rear-opening cavity disposed rearwardly in said jamb body relative to the inner side, and extending along the length of said jamb body, the rear-opening cavity being defined in part by extensions of said first and second side panels, which extend past said inner panel, the extensions of said first and second side panels having terminal ends, the rear-opening cavity having a front and a rear, the front of the rear-opening cavity being defined by said inner panel, said inner panel extending between the extensions of the first and second side panels, the rear-opening cavity further comprising an elongate rear opening extending along the length of said jamb body rearwardly of said inner panel and thereby enabling an insert in the rear-opening cavity to extend, from inside the rear-opening cavity, outwardly beyond the terminal ends of the extensions of said first and second side panels.

19. A door jamb assembly as in claim 12, further comprising a rear-opening cavity disposed rearwardly in said jamb assembly, an insert being disposed in the rear-opening cavity, said insert having an end surface (ES) facing, and proximate, the inner side.

20. A door jamb assembly as in claim 12, the first and second sides comprising respective first and second side panels, further comprising a rear-opening cavity disposed relatively rearwardly of the inner side, in said jamb body, and extending along the length of said jamb body, the rear-opening cavity being defined in part by extensions of said first and second side panels rearwardly from said inner side, further comprising an insert in the cavity, said insert having first and second side walls, recesses and protuberances collectively disposed in said extensions of said first and second side panels of said jamb body, and in said first and second side walls of said insert, cooperating with each other thereby to hold said insert in the rear-opening cavity, and wherein said first and second side panels of the cavity have terminal ends (355), and wherein said insert extends rearward of said terminal ends (355) and outwardly of the cavity.

21. A door jamb assembly as in claim 12, said mounting fin being adapted to being locked in the erected orientation, and to being unlocked from the erected orientation and moved to a retracted orientation wherein a portion of said mounting fin can lie against the second side of said jamb body.

22. A door jamb assembly as in claim 12, said mounting fin being adapted to being locked in the erected orientation, and to being unlocked from the erected orientation and rotated toward the second side of said jamb body, the unlocking of said mounting fin from the erected and locked orientation being effected by pulling said mounting fin in a direction generally perpendicularly away from the second side of said jamb body.

23. A door frame assembly made using left and right door jamb assemblies as in claim 12 in combination with a header jamb.

24. A door jamb assembly as in claim 12 wherein said jamb body comprises an extruded aluminum door jamb.

25. A door jamb assembly as in claim 12, comprising a jamb substrate, and an extruded aluminum jamb cover mounted over said jamb substrate, said nosing being integral with or mounted on said jamb cover.

26. A door jamb assembly, having a length, and being adapted to be received, as part of a door frame, into a rough opening in a building, said door jamb assembly comprising:
(a) a jamb body having a length, and comprising
(i) a first side facing toward such rough opening,
(ii) a second side facing away from such rough opening,
(iii) an outer side facing outwardly of such building, and
(iv) an inner side facing inwardly into such building;
(b) a nosing attached to said jamb body and extending outwardly of said building, away from said outer side of said jamb body, said nosing having a length;
(c) a single elongate mounting fin kerf extending along the length of said nosing, said mounting fin kerf having a slot-shaped opening defined by a heel side wall and a toe side wall; and
(d) an elongate generally rigid mounting fin in the kerf, said mounting fin having a base portion and a distal side,
(i) said mounting fin being movable to, and lockable in, an erected orientation wherein the distal side of said mounting fin is displaced from the second side of said jamb body, and
(ii) said mounting fin being adapted to be unlocked from the erected orientation and moved to a retracted orientation wherein a portion of said mounting fin can lie against the second side of said jamb body.

27. A door jamb assembly as in claim 26 wherein the distal side of said mounting fin contacts the second side of said jamb body when said mounting fin is in the retracted orientation.

28. A door jamb assembly as in claim 26 wherein the combination of said kerf and said base portion of said mounting fin are adapted such that said mounting fin can be unlocked from the erected orientation by pulling said mounting fin in a direction generally perpendicularly away from the second side of said jamb body.

29. A door jamb assembly as in claim 26, said jamb body having a plurality of panels defining the first side, the second side, the outer side, and the inner side, which plurality of panels collectively have an overall average panel thickness of about 0.055 inch to about 0.075 inch.

30. A door jamb assembly as in claim 26, the first side comprising a first side panel, the second side comprising a second side panel, the outer side comprising an outer side panel, and the inner side comprising an inner panel, said jamb body further comprising a rear-opening cavity disposed rearwardly in said jamb body relative to the inner side, and extending along the length of said jamb body, the rear-opening cavity being defined in part by extensions of said first and second side panels, which extend past said inner panel, the extensions of said first and second side panels having terminal ends, the rear-opening cavity having a front and a rear, the front of the rear-opening cavity being defined by said inner panel, said inner panel extending between the extensions of the first and second side panels, the rear-opening cavity further comprising an elongate rear opening extending along the length of said jamb body rearwardly of said inner panel and thereby enabling an insert in the rear-opening cavity to extend, from inside the cavity, outwardly beyond the terminal ends of the extensions of said first and second side panels.

31. A door jamb assembly as in claim 26, further comprising a rear-opening cavity disposed rearwardly in said jamb assembly, an insert being disposed in the rear-opening cavity, said insert having an end surface (ES) facing, and proximate, the inner side.

32. A door jamb assembly as in claim 26, the first and second sides comprising respective first and second side panels, further comprising a rear-opening cavity disposed relatively rearwardly of the inner side, in said jamb body, and extending along the length of said jamb body, the rear-opening cavity being defined in part by extensions of said first and second side panels rearwardly from said inner side, further comprising an insert in the cavity, said insert having first and second side walls, recesses and protuberances collectively disposed in said extensions of said first and second side panels of said jamb body, and in said first and second side walls of said insert, cooperating with each other thereby to hold said insert in the rear-opening cavity, and wherein said first and second side panels of the cavity have terminal ends (355), and wherein said insert extends rearward of said terminal ends (355) and outwardly of the cavity.

33. A door jamb assembly as in claim 26, the unlocking of said mounting fin from the erected and locked orientation being effected by pulling said mounting fin in a direction generally perpendicularly away from the second side of said jamb body.

34. A door frame assembly made using left and right door jamb assemblies as in claim 26 in combination with a header jamb.

35. A door jamb assembly as in claim 26 wherein said jamb body comprises an extruded aluminum door jamb.

36. A door jamb assembly as in claim 26, comprising a jamb substrate, and an extruded aluminum jamb cover mounted over said jamb substrate, said nosing being integral with or mounted on said jamb cover.

37. A door jamb assembly, having a length, and being adapted to be received, as part of a door frame, into a rough opening in a building, said door jamb assembly comprising:
(a) a jamb body having a length, and comprising
(i) a first side facing toward such rough opening,
(ii) a second side facing away from such rough opening,
(iii) an outer side facing outwardly of such building, and
(iv) an inner side facing inwardly into such building;
(b) a nosing attached to said jamb body and extending outwardly of said building, away from said outer side of said jamb body, said nosing having a length;
(c) a single elongate mounting fin kerf extending along the length of said nosing, said mounting fin kerf having a slot-shaped opening defined by a heel side wall and a toe side wall; and
(d) an elongate generally rigid mounting fin in the kerf,
(i) said mounting fin being movable to, and lockable in, an erected orientation wherein a distal side of said mounting fin is displaced from the second side of said jamb body, and
(ii) said mounting fin being adapted to be unlocked from the erected orientation and rotated toward the second side of said jamb body,
the unlocking of said mounting fin from the erected and locked orientation being effected by pulling said mounting fin in a direction generally perpendicularly away from the second side of said jamb body.

38. A door jamb assembly as in claim 37, said jamb body comprising an aluminum extrusion having a plurality of panels defining the first side, the second side, the outer side, and the inner side, which plurality of panels collectively have an overall average panel thickness of about 0.055 inch to about 0.075 inch.

39. A door jamb assembly as in claim 37, the first side comprising a first side panel, the second side comprising a second side panel, the outer side comprising an outer side panel, and the inner side comprising an inner panel, said jamb body further comprising a rear-opening cavity disposed rearwardly in said jamb body relative to the inner side, and extending along the length of said jamb body, the rear-opening cavity being defined in part by extensions of said first and second side panels, which extend past said inner panel, the extensions of said first and second side panels having terminal ends, the rear-opening cavity having a front and a rear, the front of the rear-opening cavity being defined by said inner panel, said inner panel extending between the extensions of the first and second side panels, the rear-opening cavity further comprising an elongate rear opening extending along the length of said jamb body rearwardly of said inner panel and thereby enabling an insert in the rear-opening cavity to extend, from inside the cavity, outwardly beyond the terminal ends of the extensions of said first and second side panels.

40. A door jamb assembly as in claim 37, further comprising a rear-opening cavity disposed rearwardly in said jamb assembly, an insert being disposed in the rear-opening cavity, said insert having an end surface (ES) facing, and proximate, said inner panel.

41. A door jamb assembly as in claim 37, the first and second sides comprising respective first and second side panels, further comprising a rear-opening cavity disposed relatively rearwardly of the inner side, in said jamb body, and extending along the length of said jamb body, the rear-opening cavity being defined in part by extensions of said first and second side panels rearwardly from said inner side, further comprising an insert in the cavity, said insert having first and second side walls, recesses and protuberances collectively disposed in said extensions of said first and second side panels of said jamb body, and in said first and second side walls of said insert, cooperating with each other thereby to hold said insert in the rear-opening cavity, and wherein said first and second side panels of the cavity have terminal ends (355), and wherein said insert extends rearward of said terminal ends (355) and outwardly of the cavity.

42. A door frame assembly made using left and right door jambs as in claim 37 in combination with a header jamb.

43. A door jamb assembly as in claim 37 wherein said jamb body comprises an extruded aluminum door jamb.

44. A door jamb assembly as in claim 37, comprising a jamb substrate, and an extruded aluminum jamb cover mounted over said jamb substrate, said nosing being integral with or mounted on said jamb cover.
